(19) United States
(12) Patent Application Publication
(10) Pub. No.: US 2026/0330356 A1
(43) Pub. Date: Oct. 22, 2026

(54) SYSTEMS FOR PROJECT MANAGEMENT

(71) Applicant: YIZHI TECHNOLOGY (CHENGDU) CO., LTD., Chengdu (CN)

(72) Inventors: Yonggang LIU, Chengdu (CN); Junjie LIU, Chengdu (CN); Jian HE, Chengdu (CN); Zhuochang LEI, Chengdu (CN)

(73) Assignee: YIZHI TECHNOLOGY (CHENGDU) CO., LTD., Chengdu (CN)

(21) Appl. No.: 19/664,965

(22) Filed: Apr. 30, 2026

Related U.S. Application Data
(63) Continuation of application No. PCT/CN2025/143234, filed on Dec. 17, 2025.

(30) Foreign Application Priority Data
Apr. 16, 2025 (CN) 202510474190.9
Nov. 17, 2025 (CN) 202511681452.5

(51) Int. Cl. G06Q 10/0631; G06Q 50/08

(52) U.S. Cl. CPC G06Q 10/06313; G06Q 50/08

(57) ABSTRACT

Disclosed is a system for project management, the system is configured to: construct, based on construction area data and progress node data of a target project, a data structure of a construction progress matrix; query, based on feature values of project features of the target project, a pre-built general document directory library for matching candidate project documents, to generate and store a first document directory; screen out a second project document from a plurality of first project documents, and generate a second document directory corresponding to a target matrix unit; monitor, in real time, a status change event of the second project document by a listener deployed on a business database which corresponds to the second project document and is specified by a database tag; and automatically update, in response to detecting the status change event, index information corresponding to the second project document in the second document directory.

### CROSS-REFERENCE TO RELATED APPLICATIONS

This application is a Continuation of International Application No. PCT/CN2025/143234, filed on Dec. 17, 2025, which claims priority to Chinese Patent Application No. 202510474190.9, filed on Apr. 16, 2025, and Chinese Patent Application No. 202511681452.5, filed on Nov. 17, 2025, the entire contents of each of which are hereby incorporated by reference.

### TECHNICAL FIELD

The present disclosure relates to the field of project management, and in particular, to a system for project management.

### BACKGROUND

In modern engineering project management, project documents, as an important component of project management, come in a wide variety and involve a plurality of business processes. The project documents encompass records of various stages of a project, including design, construction, and supervision, and are closely related to project progress, project quality, project safety, etc. Traditional project document management relies on folder structures for document storage and management, making document retrieval cumbersome and inefficient. Additionally, different business systems store different project documents, and decentralized storage of the project documents makes it difficult to achieve global unified management. On the other hand, there is almost no correlation between document storage and project progress. Consequently, the project documents may only serve a purpose of information recording without an ability to play a more significant role.

Therefore, it is necessary to provide a system for project management to improve a management efficiency of project documents, while also enabling the project documents to play a more significant role by establishing an association between the project documents and an actual project progress.

### SUMMARY

One or more embodiments of the present disclosure provide a system for project management. The system includes at least one processor and a memory storing computer instructions. When the at least one processor executes the computer instructions, the system is configured to: construct, based on construction area data and progress node data of a target project, a data structure of a construction progress matrix in the memory, wherein the data structure includes a plurality of matrix units, and each of the plurality of matrix units is uniquely associated with a construction area and a progress node; query, based on feature values of project features of the target project, a pre-built general document directory library for matching candidate project documents, to generate and store a first document directory in the memory, wherein the first document directory records document tags of a plurality of first project documents corresponding to the target project, and a document tag includes a construction area tag, a progress node tag, and a database tag identifying a storage position; for a target matrix unit in the data structure of the construction progress matrix, screen out a second project document from the plurality of first project documents by matching and querying construction area data and progress node data of the target matrix unit with construction area tags and progress node tags of the plurality of first project documents, and generate a second document directory corresponding to the target matrix unit; monitor, in real time, a status change event of the second project document by a listener deployed on a business database which corresponds to the second project document and is specified by the database tag; and automatically update, in response to detecting the status change event, index information corresponding to the second project document in the second document directory.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an application scenario of a system for project management according to some embodiments of the present disclosure;

FIG. 2 is a schematic diagram illustrating exemplary hardware and software components of an exemplary computing device according to some embodiments of the present disclosure;

FIG. 3 is a block diagram illustrating an exemplary system for project management according to some embodiments of the present disclosure;

FIG. 4 is a flowchart illustrating an exemplary process for project management according to some embodiments of the present disclosure;

FIG. 5 is a flowchart illustrating an exemplary process for storing project documents according to some embodiments of the present disclosure;

FIG. 6 is a schematic diagram illustrating an exemplary second document directory according to some embodiments of the present disclosure;

FIG. 7 is a schematic diagram illustrating an exemplary process for determining first project documents and generating a first document directory according to some embodiments of the present disclosure;

FIG. 8 is a flowchart illustrating an exemplary process for managing construction progress based on an updated second project document according to some embodiments of the present disclosure;

FIG. 9 is a schematic diagram illustrating an exemplary progress display table according to some embodiments of the present disclosure;

FIG. 10 is a flowchart illustrating an exemplary process for assigning construction tasks based on visual progress according to some embodiments of the present disclosure;

FIG. 11 is a schematic diagram illustrating an exemplary visualization view according to some embodiments of the present disclosure;

FIG. 12 is a flowchart illustrating an exemplary process for determining a priority of a first task to be assigned according to some embodiments of the present disclosure;

FIG. 13 is a schematic diagram illustrating an exemplary process for generating a construction task sheet corresponding to each matrix unit according to some embodiments of the present disclosure; and

FIG. 14 is a flowchart illustrating an exemplary process for reassigning a second task to be assigned according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

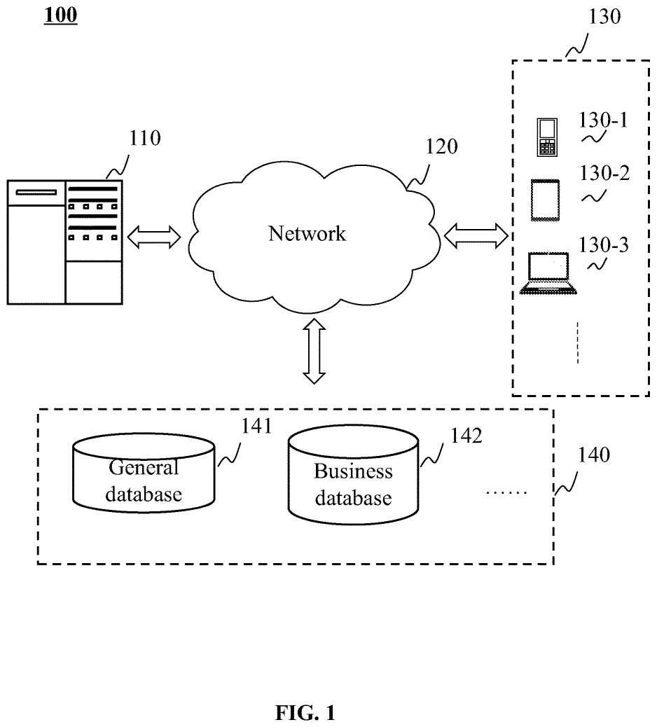

FIG. 1 is a schematic diagram illustrating an application scenario of a system for project management according to some embodiments of the present disclosure. As shown in FIG. 1, the application scenario (hereinafter referred to as an application scenario 100) of the system for project management may include a processing device 110, a network 120, a terminal 130, and a database 140. In some embodiments, the system for project management may be configured to perform methods and/or processes disclosed in the present disclosure.

The processing device 110 may be configured to process data and/or information from various components of the application scenario 100 and/or external data sources. The processing device 110 may execute program instructions based on the data, information, and/or processing results, to perform one or more functions described in the present disclosure. The processing device 110 may perform a method for project management described in any embodiment of the present disclosure. For example, the processing device 110 may construct, based on construction area data and progress node data of a target project, a data structure of a construction progress matrix in a memory; query, based on feature values of project features of the target project, a pre-built general document directory library for matching candidate project documents, to generate and store a first document directory in the memory; for a target matrix unit in the data structure of the construction progress matrix, screen out a second project document from a plurality of first project documents by matching and querying construction area data and progress node data of the target matrix unit with construction area tags and progress node tags of the plurality of first project documents, and generate a second document directory corresponding to the target matrix unit; monitor, in real time, a status change event of the second project document by a listener deployed on a business database which corresponds to the second project document and is specified by a database tag; and automatically update, in response to detecting the status change event, index information corresponding to the second project document in the second document directory.

In some embodiments, the processing device 110 may be a single server or a server group. In some embodiments, the server may include a processor, and the server group may be centralized or distributed. In some embodiments, the processing device 110 may be local or remote. In some embodiments, the processing device 110 may be implemented on a cloud platform. For example, the cloud platform may include a private cloud, a public cloud, a hybrid cloud, or any combination thereof.

The network 120 may include any suitable network configured to facilitate information and/or data exchange. In some embodiments, one or more components of the application scenario 100 may exchange information and/or data through the network 120. For example, the processing device 110 may obtain the index information of the second project document through the network 120. The network 120 may include a local area network (LAN), a wide area network (WAN), a wired network, a wireless network, or any combination thereof.

The terminal 130 refers to one or more terminal devices used by a user. In some embodiments, the user includes project management personnel, construction personnel, acceptance personnel, or the like. In some embodiments, the terminal 130 may include a mobile phone 130-1, a tablet 130-2, a computer 130-3, or the like.

The database 140 may store data or information generated by other devices. In some embodiments, the database 140 may include a memory, the memory stores computer instructions, and when at least one processor executes the computer instructions, the system for project management is configured to perform the method for project management described in any embodiment of the present disclosure.

In some embodiments, the database 140 may store project documents, for example, the first project document, the second project document, a third project document, a fourth project document, or the like. In some embodiments, the database 140 may store data and/or information processed by the processing device 110, for example, the index information, monitoring information, or the like. The database 140 may include one or more database components, each of the database components may be an independent device or a part of other devices. The database 140 may be local or may be implemented via a cloud. In some embodiments, the database 140 may be implemented on the cloud platform.

In some embodiments, the database 140 includes a general database 141, a business database 142, or the like.

The general database 141 is configured to store project documents not directly related to construction business. For example, the general database 141 may store general project documents, general standard project documents, regulations, or the like. The construction business includes, but is not limited to, construction business execution, construction business acceptance, and construction business supervision.

The business database 142 is configured to store project documents related to the construction business. For example, the business database 142 may store project documents related to businesses such as the construction business acceptance, the construction business execution, and the construction business supervision (e.g., acceptance documents, business progress documents, business execution logs, or the like).

In some embodiments, the business database 142 may establish one or more sub-databases for storing project documents corresponding to different construction businesses. For example, the business database 142 may establish an acceptance business database to store documents related to the construction business acceptance, such as acceptance reports, acceptance records, or the like. The business database 142 may also establish a supervision business database to store documents related to the construction business supervision, such as supervision logs, safety inspection records, or the like.

In some embodiments, the database 140 may also include a capability database.

The capability database is configured to store detailed capability and performance profiles of all available performance entities. For example, the capability database may store at least one of a professional qualification, a skill level, a historical capacity level, a current workload, and historical performance data (such as a duration compliance rate, a quality pass rate, a safety record, or the like) of each construction team, work squad, or subcontractor.

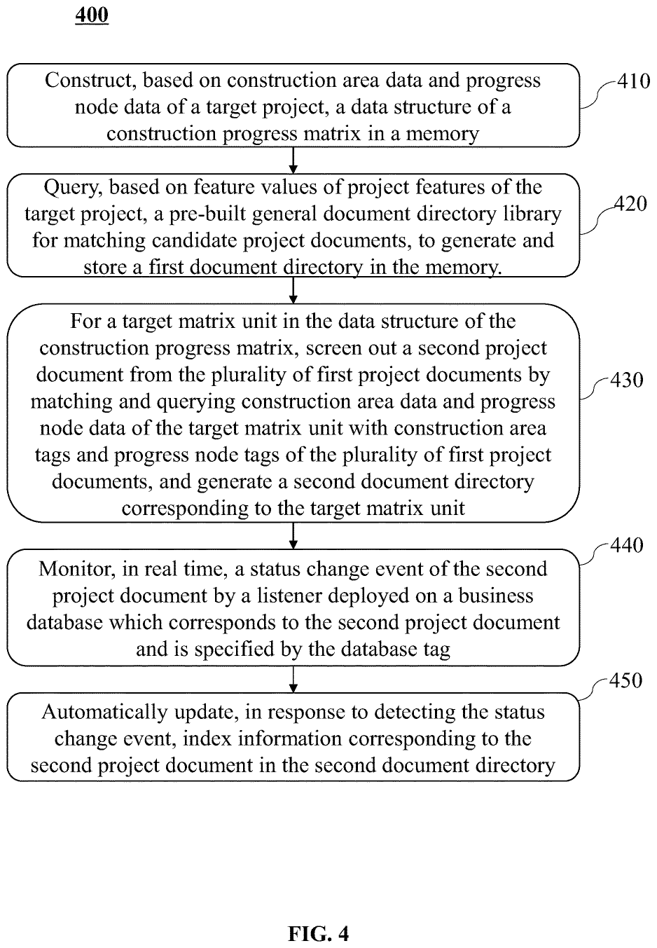

In some embodiments, the database 140 may also include a document directory library, or the like. For more details, please refer to FIG. 4 and related descriptions thereof.

It should be noted that the application scenario 100 is provided merely for illustrative purposes and is not intended to limit the scope of the present disclosure. For a person of ordinary skill in the art, various modifications or variations may be made based on the description of the present disclosure. For example, the application scenario 100 may implement similar or different functions on other devices. However, the variations and modifications may not depart from the scope of the present disclosure.

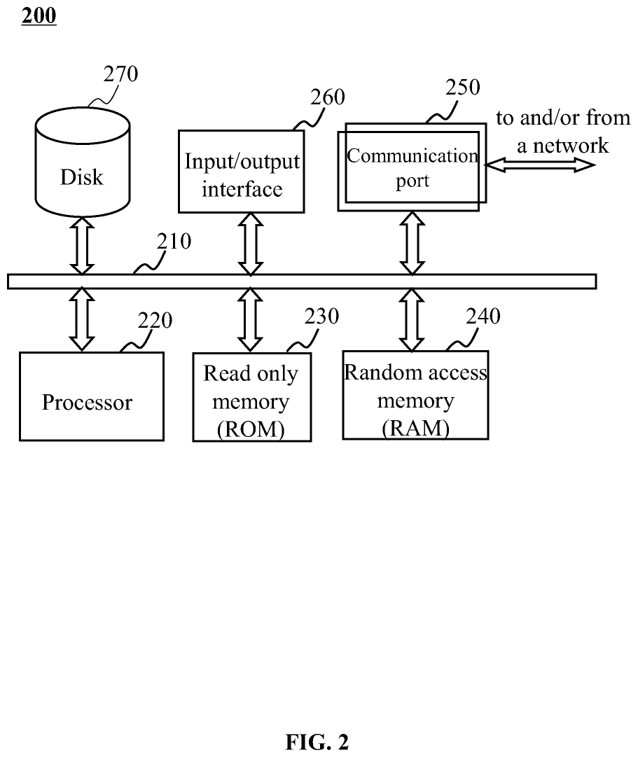

FIG. 2 is a schematic diagram illustrating exemplary hardware and software components of an exemplary computing device according to some embodiments of the present disclosure. A computing device 200 may be configured to perform one or more functions of various modules in the system for project management disclosed in some embodiments of the present disclosure.

The computing device 200 may be a general purpose computer or a special purpose computer, both of which may be configured to implement the system for project management of the present disclosure. The computing device 200 may be configured to implement any component of the system for project management as described in the present disclosure. For example, a processor may be implemented on the computing device 200 through hardware, software programs, firmware, or a combination thereof. For convenience, only a single computer is shown in the figure, but computer functions described in the present disclosure may be implemented in a distributed manner on a plurality of similar platforms to distribute a processing load.

For example, the computing device 200 may include a communication port 250 which is connected to and/or from a network to achieve data communication. The computing device 200 may also include a processor 220 in a form of one or more processors, configured to execute program instructions. An exemplary computer platform may include an internal communication bus 210, different types of program memory and data memory (for example, a disk 270, a read only memory (ROM) 230, or a random access memory (RAM) 240), and various data files processed and/or transmitted by the computer. The exemplary computer platform also includes computer instructions stored in the ROM 230, the RAM 240, and/or other forms of non-transitory storage media, which are executed by the processor 220. The methods and/or processes of the present disclosure may be implemented through computer instructions. The computing device 200 may also include an input/output interface 260 that supports input/output between the computer and other components. The computing device 200 may also receive programming and data via network communication.

Merely for illustration, only a CPU and/or processor is exemplarily described in the computing device 200. However, it should be noted that the computing device 200 of the present disclosure may include a plurality of CPUs and/or processors, so operations and/or methods described in the present disclosure and implemented by the CPU and/or processor may also be implemented jointly or independently by the plurality of CPUs and/or processors. For example, if in the present disclosure, the CPU and/or processor of the computing device 200 performs operation A and operation B, it should be understood that the operation A and the operation B may also be performed jointly or independently by two different CPUs and/or processors in the computing device 200 (for example, a first processor performs the operation A and a second processor performs the operation B, or the first processor and the second processor jointly perform the operation A and the operation B).

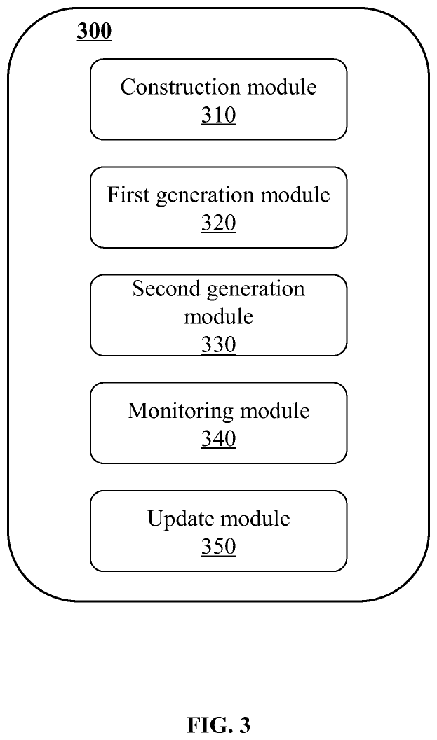

FIG. 3 is a block diagram illustrating an exemplary system for project management according to some embodiments of the present disclosure.

In some embodiments, as shown in FIG. 3, the system for project management (hereinafter referred to as a system 300) may include a construction module 310, a first generation module 320, a second generation module 330, a monitoring module 340, and an update module 350. The construction module 310, the first generation module 320, the second generation module 330, the monitoring module 340, and the update module 350 are implemented by one or more processing devices or processors.

In some embodiments, the construction module 310 is configured to construct, based on construction area data and progress node data of the target project, a data structure of a construction progress matrix in a memory. The data structure includes a plurality of matrix units, and each of the plurality of matrix units is uniquely associated with a construction area and a progress node.

In some embodiments, the first generation module 320 is configured to query, based on feature values of project features of the target project, a pre-built general document directory library for matching candidate project documents, to generate and store a first document directory in the memory. The first document directory records document tags of a plurality of first project documents corresponding to the target project, and a document tag includes a construction area tag, a progress node tag, and a database tag identifying a storage position.

In some embodiments, the second generation module 330 is configured to, for a target matrix unit in the data structure of the construction progress matrix, screen out a second project document from the plurality of first project documents by matching and querying construction area data and progress node data of the target matrix unit with construction area tags and progress node tags of the plurality of first project documents, and generate a second document directory corresponding to the target matrix unit.

In some embodiments, the monitoring module 340 is configured to monitor, in real time, a status change event of the second project document by a listener deployed on a business database which corresponds to the second project document and is specified by the database tag.

In some embodiments, the update module 350 is configured to automatically update, in response to detecting the status change event, index information corresponding to the second project document in the second document directory.

For more details about the system 300, please refer to FIGS. 4 to 14 and related descriptions thereof.

It should be noted that the above description of the system 300 and the modules thereof is merely for convenience of description and does not limit the present disclosure to the scope of the disclosed embodiments. It may be understood that for a person skilled in the art, after understanding the principle of the system, various modules may be arbitrarily combined or formed into subsystems connected to other modules without departing from this principle. In some embodiments, the construction module 310, the first generation module 320, the second generation module 330, the monitoring module 340, and the update module 350 disclosed in FIG. 1 may be different modules in a system, or one module may implement the functions of two or more of the above-described modules. For example, the various modules, may share a storage module, and the various modules may also individually have their respective storage modules. Variations such as these are all within the protection scope of the present disclosure.

FIG. 4 is a flowchart illustrating an exemplary process for project management according to some embodiments of the present disclosure. As shown in FIG. 4, a process 400 includes the following operations 410-450. In some embodiments, the process 400 may be performed by a processor.

In 410, a data structure of a construction progress matrix is constructed in a memory based on construction area data and progress node data of a target project.

The target project refers to a construction project for which project document management is to be performed. The construction project may include a plurality of engineering types. For example, the construction project may include various types of construction projects, such as building engineering, decoration and renovation engineering, installation engineering, municipal engineering, landscape engineering, or the like. The construction project may be further divided into various building engineering projects, for example, residential buildings, commercial complexes, infrastructure projects, or the like.

The target project involves a plurality of construction areas, and each construction area involves a plurality of progress nodes. The construction area refers to an area in the target project that needs to be constructed. The progress node refers to a construction phase that the construction area is to experience during a construction process. For example, taking a construction project of the building engineering type as the target project, the construction areas include various floor areas, such as a first floor, a second floor, or the like. For each construction area, the progress nodes thereof include main body construction, electromechanical pre-reservation and pre-embedding, electromechanical installation, or the like.

The construction area may be an area obtained by performing unit division on the construction project spatially or functionally for ease of management. The construction area data refers to data used to describe features of the construction area. In some embodiments, the construction area data of each construction area may include a name, position information, or the like, of the construction area. In some embodiments, the construction area data may also include a construction object within the construction area. For example, a “living room” (e.g., the “living room” of unit 201 on the second floor of Building No. 1) may have a construction object such as load-bearing walls, ceilings, floors, or the like.

The plurality of progress nodes may be a plurality of phased sub-targets of a construction area in a construction project. For example, in a building project, the progress nodes may include “foundation and basement engineering”, “main structure engineering”, “decoration and renovation engineering”, or the like. The progress node data refers to data used to characterize content of the progress nodes.

The data structure of the construction progress matrix refers to a data structure of a two-dimensional matrix corresponding to the target project, one dimension of the data structure of the matrix corresponds to the construction area, and the other dimension corresponds to the progress nodes. In some embodiments, after combining the construction area data and the progress node data, the data structure of the construction progress matrix may be formed.

In some embodiments, the data structure of the construction progress matrix may include a plurality of matrix units. The matrix unit refers to a constituent unit in the construction progress matrix. The matrix unit may be regarded as the smallest unit of project document management. Each matrix unit corresponds to a construction area and a progress node in the target project, that is, each matrix unit in the plurality of matrix units is uniquely associated with a construction area and a progress node. For example, with a two-dimensional construction progress matrix, the data structure of the construction progress matrix is composed of a plurality of matrix units and may be represented by the following formula (1):

M=[(Aᵢ−Bⱼ)]_{m×n} (1),

where M denotes the data structure of the construction progress matrix, Aᵢ denotes an i-th construction area, Bⱼ denotes a j-th progress node, (Aᵢ−Bⱼ) denotes a matrix unit, and m×n is a count of rows and a count of columns of the matrix unit, respectively denoting a count of the construction areas and a count of the progress nodes.

For example, for a target project including 2 floors and 2 progress nodes, the data structure of the construction progress matrix may be represented as

$$M = [ \begin{matrix}{A}_{1} - {B}_{1} & {A}_{2} - {B}_{1} \\ {A}_{1} - {B}_{2} & {A}_{2} - {B}_{2}\end{matrix} ] .$$

As another example, in the data structure in a two-dimensional matrix, the construction area data are vertical areas such as floors (e.g., a first floor, a second floor, etc.), and the progress node data are horizontal construction stages (e.g., main body, secondary structure, electromechanical pre-reservation and pre-embedding, etc.).

In some embodiments, the processor may construct the data structure of the construction progress matrix based on the construction area data and the progress node data of the target project. For example, the processor may obtain the construction area data of the plurality of construction areas and the progress node data of the plurality of progress nodes in the target project, and combine the plurality of construction areas and the plurality of progress nodes to form the plurality of matrix units, thereby generating the data structure of the construction progress matrix.

In some embodiments, the processor may automatically divide and generate the data structure of the construction progress matrix corresponding to the target project, based on the type of the target project, the construction area data (e.g., floors), the progress node data (e.g., construction stages), or the like. Each matrix unit corresponds to a data combination of a specific construction area and a specific progress node. For example, the matrix unit may include an engineering type to which the target project belongs (e.g., housing construction, municipal engineering, airport, etc.), the construction area data corresponding to the matrix unit (e.g., a count or sequence number of floors or a count or sequence number of buildings, etc.) and the progress node data (e.g., nodes included in a main construction stage, including main body, masonry, decoration, installation, etc.).

The type of the target project, the construction area data, and the progress node data may be extracted from a paper construction plan or an electronic construction plan of the target project, or input by a user (e.g., project management personnel) through a terminal device. For example, the processor may use optical character recognition (OCR) technology to scan the paper construction plan of the target project and extract information related to the construction areas and the progress nodes.

It should be understood that, the progress nodes corresponding to different construction areas may be the same or different. When the progress nodes corresponding to different construction areas are the same, each matrix unit in the data structure of the construction progress matrix is an effective matrix unit and may be used for the project document management in subsequent operations. When the progress nodes corresponding to different construction areas are different, only a portion of the matrix units in the data structure of the construction progress matrix are effective matrix units, and the remaining invalid matrix units may not be used for the project document management in subsequent operations. For example, when a construction area A has a progress node 1 and a progress node 2, and a construction area B only has the progress node 1, the matrix unit corresponding to the construction area B and the progress node 2 is an invalid matrix unit and may not be used in subsequent operations.

In 420, a pre-built general document directory library is queried for matching candidate project documents based on feature values of project features of the target project, to generate and store a first document directory in the memory.

The project feature refers to a feature of the construction project, including but not limited to an engineering type, a construction region, a construction unit, a construction contractor, or the like. The feature value refers to a specific value of a project feature. The feature value is an attribute of the target project itself, and each construction project has only one set of feature values. For example, the feature values of the project features of the target project may be: the engineering type is housing construction engineering, the construction region is Sichuan, the construction unit is Vanke Group, the construction contractor is China State Construction Engineering Corporation, or the like.

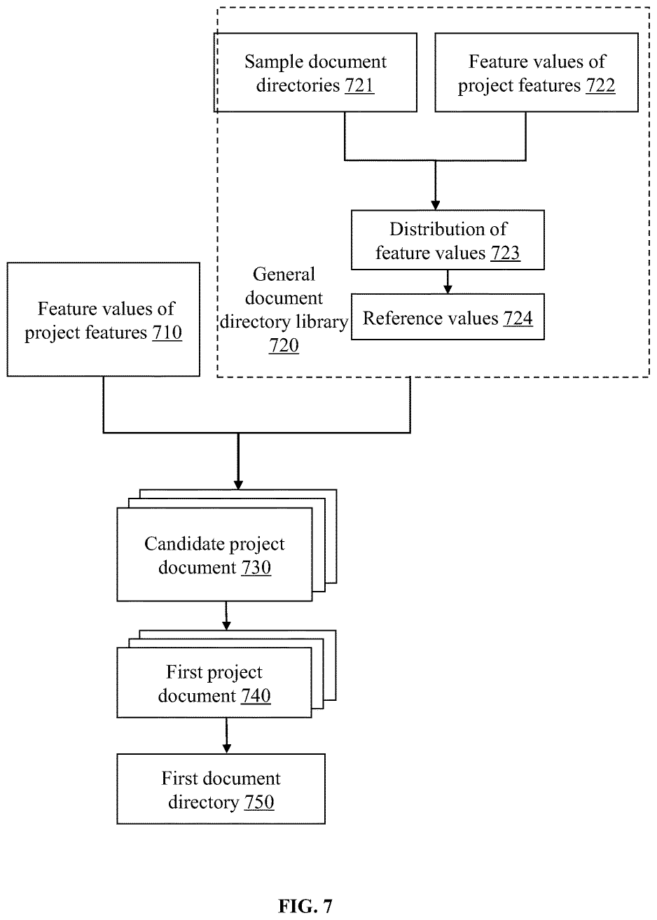

The general document directory library refers to a document directory library that is general for a plurality of types of projects, for storing information related to project documents corresponding to the plurality of types of projects. In some embodiments, the general document directory library is configured to store a correspondence between reference values of the project features and a plurality of types of project documents, and a document tag of each type of project document. The document tags of the project document may be set by the user. For more details about how to construct the general document directory library, please refer to FIG. 7 and related descriptions thereof.

The candidate project documents refer to project documents in the general document directory library that match the target project. The candidate project documents are candidate document types applicable to the target project.

In some embodiments, the processor may obtain the general document directory library, screen out document types that are the same as the feature values (e.g., the construction region, the engineering type, the construction entity, etc.) of the target project from the general document directory library based on the reference values of the project features corresponding to the plurality of types of project documents in the general document directory library, and determine the document types as the candidate project documents. For example, if the target project is a housing construction engineering project and is located in Sichuan Province, the processor may screen out document types suitable for the housing construction engineering project and the Sichuan region from the general document directory library based on the reference values, for example, “Rebar Concealed Acceptance Form”, “Formwork Concealed Acceptance Form”, “Construction log”, or the like.

The reference value refers to a typical feature value of the project feature. The general document directory library may store a correspondence between the reference values of the project features and the plurality of types of project documents may be stored, i.e., the reference values of the project features corresponding to the plurality of types of project documents. For a certain type of project documents, if reference values of project features corresponding to the certain type of project documents is A, it means that a project with the feature value of A typically has the certain type of project documents. For example, for the “Rebar Concealed Acceptance Form”, the reference values for the engineering type and the construction region are “housing construction project” and “Guangdong Province and Zhejiang Province”, respectively, which indicates that housing construction projects in Guangdong Province and Zhejiang Province typically require the “Rebar Concealed Acceptance Form”.

The first document directory refers to a directory for storing information (e.g., a document name, a document type, etc.) related to first project documents corresponding to the target project. The first project document refers to a project document which may be generated during an entire process of the target project and needs to be stored. For example, the first project document includes a construction log, a construction inspection document, or the like, of the target project. The first document directory may be screened from the general document directory library.

In some embodiments, the first document directory is configured to record document tags of a plurality of first project documents corresponding to the target project. The document tag refers to a tag that identifies an attribute of the project document. The document tag includes one or more of a construction area tag, a progress node tag, a database tag identifying a storage position, a warning rule tag, a disposal rule tag, an affiliated unit tag, a construction task tag, or the like. The document tag may further include a basic information tag, such as a tag corresponding to the document name, a tag corresponding to the document type, or the like. The document tag may be used for determining a second project document.

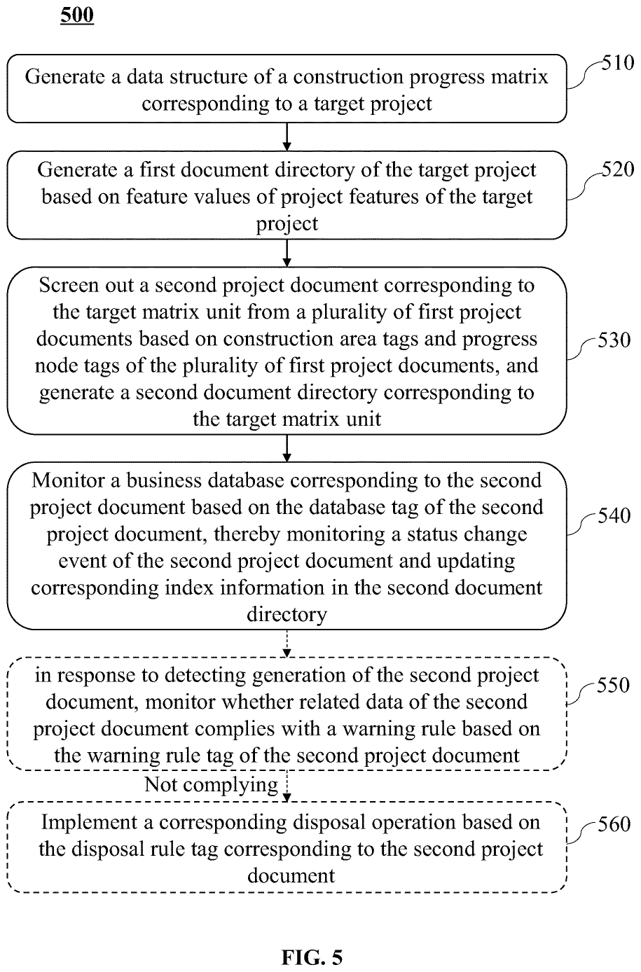

The construction area tag may identify the construction area corresponding to the project document, for example, a building, a basement, a foundation pit, a roof, or the like. The progress node tag may identify the progress node corresponding to the project document. The database tag may identify a database where the project document is stored (that is, identifying the storage position of the project document), for example, a business database, or the like. The warning rule tag may identify a warning rule associated with the project document. The disposal rule tag may identify a disposal rule associated with the project document. The affiliated unit tag may identify an affiliated unit associated with the project document. The construction task tag may identify a construction task associated with the project document. For more details about the warning rule, the disposal rule, the affiliated unit, and the construction task, please refer to FIG. 5 and related descriptions thereof.

In some embodiments, the processor may generate the first document directory in a plurality of manners. For example, a default document directory corresponding to the project features is pre-stored in the database. The default document directory corresponding to the feature values of the project features of the target project may be determined as the first document directory. Alternatively, the user (such as project management personnel) may input the first document directory based on the feature values of the project features of the target project.

In some embodiments, the processor may directly determine the candidate project documents as the first project document corresponding to the target project, and generate the first document directory. In some embodiments, the processor may screen the candidate project documents to determine the first project document, and generate the first document directory.

For more details about how to generate the first document directory, please refer to FIG. 7 and related descriptions thereof.

In some embodiments, the processor may eliminate the candidate project documents according to a preset frequency, and determine remaining documents as the first target document. For example, the processor may eliminate low-frequency documents (for example, candidate project documents with a frequency lower than 10 times or a percentage lower than 5%). In some embodiments, the processor may also recommend a document directory after eliminating the low-frequency documents to the user, and the user may choose whether to keep the low-frequency documents, and finally generate the first document directory based on a choice of the user.

In 430, for a target matrix unit in the data structure of the construction progress matrix, the second project document is screened out from the plurality of first project documents by matching and querying construction area data and progress node data of the target matrix unit with construction area tags and progress node tags of the plurality of first project documents, and a second document directory corresponding to the target matrix unit is generated.

The target matrix unit refers to a matrix unit for which project document management is to be performed. In some embodiments, the target matrix unit may be any matrix unit in the data structure of the construction progress matrix. In some embodiments, the target matrix unit may be any valid matrix unit in the data structure of the construction progress matrix. For details, please refer to operation 410 and related descriptions thereof. For convenience of description, the construction area and the progress node corresponding to the target matrix unit are referred to as a target construction area and a target progress node.

The second project document refers to a project document corresponding to the target matrix unit, that is, a project document that may be generated and need to be stored when the target construction area is at the target progress node.

In some embodiments, the processor may match and associate the construction area data and the progress node data in the target matrix unit with the construction area tags and the progress node tags of the first project documents, and determine a first project document associated with the target matrix unit as the second project document corresponding to the target matrix unit. The document tag of the first project document is inherited by the second project document.

The second document directory is a directory for storing related information of the second project document corresponding to the target matrix unit. All second project documents associated with the target matrix unit are listed in the second document directory. For example, the second document directory is configured to store index information of the second project document, instead of an entity of the second project document. As another example, the second document directory is further configured to store the document tag of the second project document.

In some embodiments, after determining the second project document, the processor may determine an associated construction area tag or an associated progress node tag of the target matrix unit in the general document directory library; and automatically associate and generate the second document directory based on the associated construction area tag and the associated progress node tag of the target matrix unit. The user may manually modify the second document directory based on the automatically generated second document directory.

In some embodiments, a form of the second project document may include an electronic document or a paper document. For example, the electronic document may be uploaded by the user through a terminal device to a corresponding business database. The paper document, such as original signed copies, needs to be scanned and uploaded by the user to the corresponding database through optical character recognition (OCR) technology.

In some embodiments, in response to determining the generation of the second project document, the processor may generate a virtual document object associated with the second project document in the target matrix unit. For example, for the electronic document, the processor may automatically call a blockchain interface to complete an evidence preservation operation when the electronic document is generated, and write content such as digest information (e.g., a hash value) and a generation time of the electronic document to the chain. For the paper document, after completing the scanning and uploading, its digest information may also be determined and stored in a blockchain to achieve unified traceability and tamper-proof protection. For more details about how to monitor the generation of the second project document, please refer to operation 440.

The virtual document object includes operation log information of the second project document. For example, the operation log information includes a plurality of pieces of data information such as creation, uploading, approval, sending and receiving, borrowing, and modification of the second project document. The data information in the operation log information may be subjected to hash comparison or metadata mapping with a timestamp and the digest information recorded by the evidence preservation of the blockchain, thereby verifying the authenticity and integrity of the second project document.

The index information is used for positioning project documents, to achieve querying and retrieval of the project documents. In some embodiments, the entity of the second project document is stored in the database corresponding to the second project document, and the index information may point to the database where the second project document is actually stored. For example, the index information includes a path, a storage address, a jump link, or the like, of the database of the project document. The user (such as project management personnel) may be positioned to the database corresponding to the second project document through the index information. For example, after the user clicks the jump link, the interface may jump from the matrix unit interface to a detailed page of the database, to view or edit document content of the second project document. The index information may be updated with a status change of the second project document. For example, when the second project document is generated and stored in the database corresponding to the second project document, the index information is updated, and updated index information may point to the second project document itself, and the second project document itself may be positioned through the updated index information. For more details regarding the index information, please refer to operation 440.

For example, if the second project document is an acceptance type document, then the entity of the second project document may be stored in an acceptance business database. The entity of the second project document is stored in corresponding business database (for example, the acceptance business database, a supervision business database, or the like), but the index information may be centrally displayed at a matrix unit level to jump to the corresponding business database.

In 440, a status change event of the second project document is monitored in real time by a listener deployed on a business database which corresponds to the second project document and is specified by the database tag.

For more details about the business database, please refer to FIG. 1 and related descriptions thereof.

The listener refers to a component or mechanism configured to monitor whether a predetermined event occurs from a specific source. For example, the listener may be a process, a service, or a computer code program deployed on the business database, for monitoring changes in data records.

Since each first project document is associated with a database tag, the second project document thus inherits the database tag, for indicating and identifying a sub-database where the second project document is stored. In some embodiments, the processor sets the listener in the sub-database where the second project document is stored based on the database tag of the second project document, wherein the listener is configured to monitor, in real time, the status change event of the second project document in the sub-database.

The status change event of the second project document includes generation, approval, modification, deletion, or the like. As described in operation 430, when the second document directory is generated, the index information of the second project document points to the database corresponding to the second project document.

In some embodiments, the processor may set the listener in the database corresponding to the second project document based on the database tag of the second project document, to monitor status changes of the second project document.

In 450, in response to detecting the status change event, the index information corresponding to the second project document in the second document directory is automatically updated.

In some embodiments, after the listener detects the status change event (such as the creation, the modification, the approval, the deletion, or the like) of the second project document in the database, the processor may automatically update the latest document status and index information synchronously into the second document directory of the target matrix unit.

In some embodiments, when generation of the second project document is detected, the index information may be automatically updated to point to the second project document itself. For example, the index information may be automatically updated to a jump link corresponding to the second project document, through which the second project document may be opened. In some embodiments, when deletion of the second project document is detected, the index information may be automatically re-updated to point back to the database corresponding to the second project document. When a storage address of the second project document is modified, the index information may be automatically updated to point to a new storage address of the second project document.

For example, when a document X (for example, “concrete pouring order”) is created or modified in the acceptance business database, the listener in the acceptance business database may detect that the document X officially generates a database record or a status change event (for example, a change from unapproved to approved) of the document X. The listener sends the status change event to the processor, and after the processor receives related information of the status change event, the processor automatically updates the index information of the second project document corresponding to the matrix unit in the second document directory to “generated”, “uploaded”, or “approved”, or the like, and updates a corresponding link/URL in the second document directory. In this manner, when the user enters the matrix unit next time, the user may see that the document is in a new status such as “completed” or “viewable”, thereby clicking on the link to jump to view details.

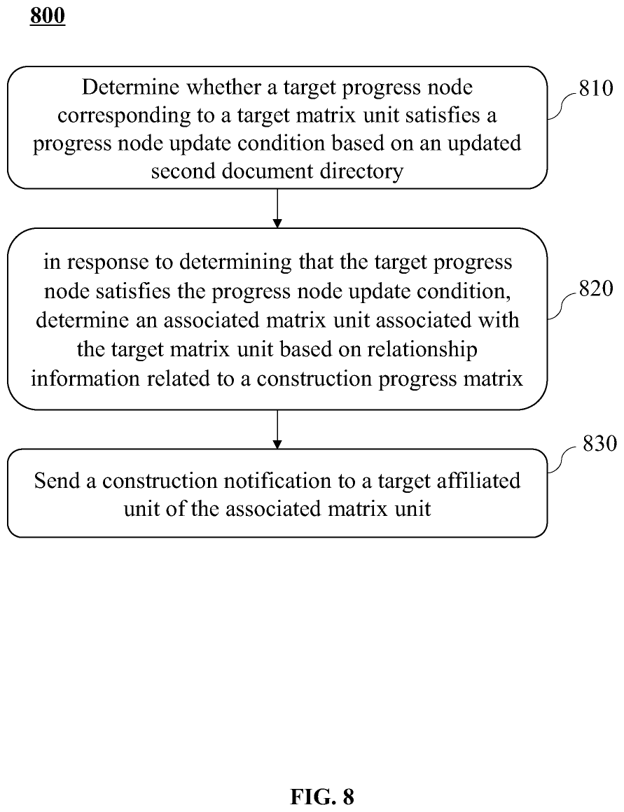

In some embodiments, the processor may further determine, based on the updated second document directory, whether the target progress node corresponding to the target matrix unit satisfies a progress node update condition; in response to determining that the target progress node satisfies the progress node update condition, determine an associated matrix unit associated with the target matrix unit based on relationship information related to the data structure of the construction progress matrix; and send a construction notification to a target affiliated unit of the associated matrix unit. For more details about how to determine whether the target progress node satisfies the progress node update condition, the associated matrix unit, and the process for sending the construction notification to the associated matrix unit, please refer to FIG. 8 and related descriptions thereof.

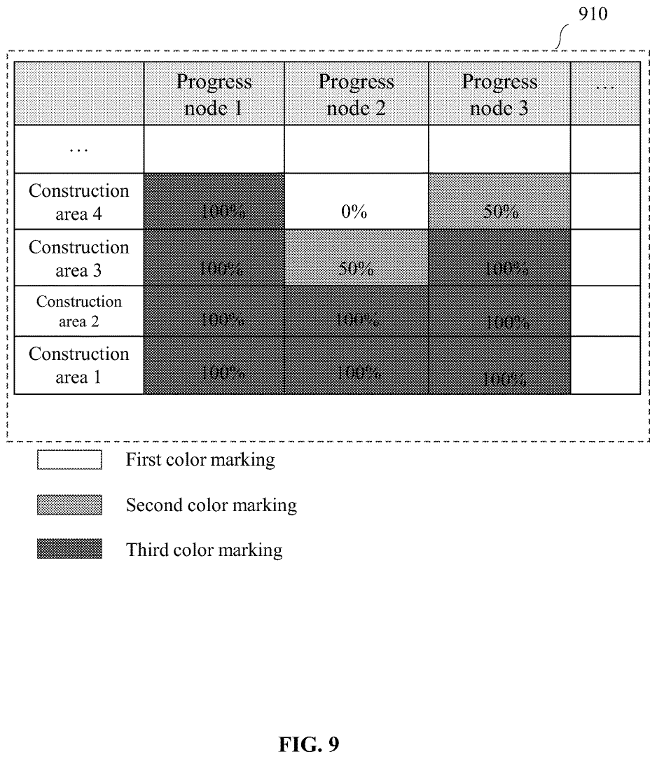

In some embodiments, the processor may further generate a progress display table corresponding to the data structure of the construction progress matrix, wherein the progress display table includes display cells corresponding to the plurality of matrix units; determine, based on the updated second document directory, progress information of the target matrix unit; and annotate, based on the progress information, a display cell corresponding to the target matrix unit in the progress display table. For more details about how to generate the progress display table, determine the progress information of the target matrix unit, and annotate the display cell in the target matrix unit, please refer to FIG. 9 and related descriptions thereof.

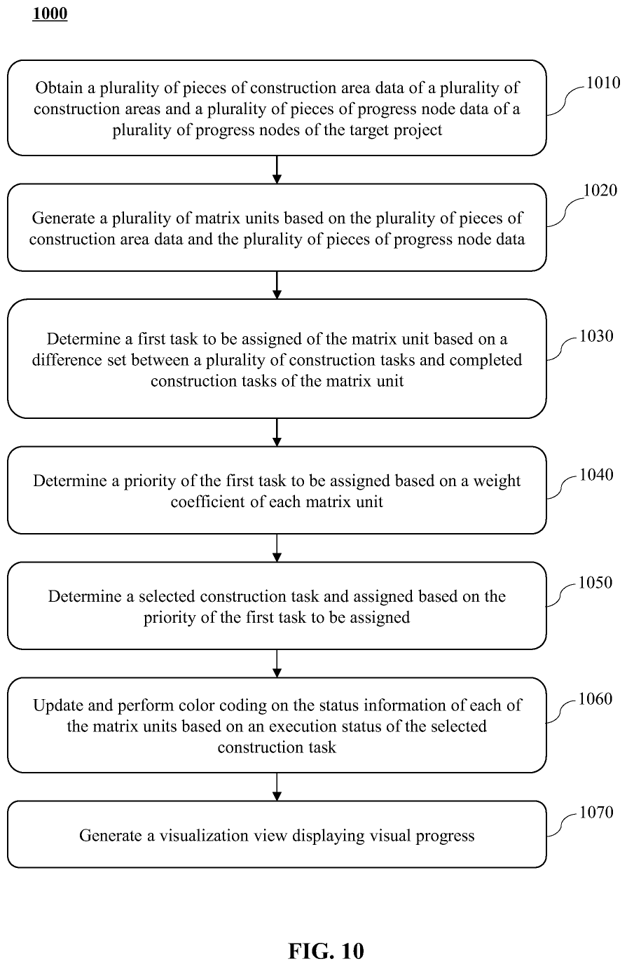

In some embodiments, for each of the plurality of matrix units, the processor may: determine, based on a difference set between a plurality of construction tasks and completed construction tasks of the matrix unit, a first task to be assigned of the matrix unit; determine, based on a weight coefficient of the matrix unit, a priority of the first task to be assigned; determine a selected construction task based on the priority of the first task to be assigned and assign the selected construction task; update and perform color coding on status information of the matrix unit based on an execution status of the selected construction task; and generate a visualization view displaying visual progress, wherein the visualization view includes a view presented in a two-dimensional table format; and in the view presented in the two-dimensional table format, a vertical axis displays a plurality of construction areas of the target project, and a horizontal axis displays a plurality of progress nodes of the target project. For more details about how to determine the first task to be assigned and the priority, determine and assign the selected construction task, update and perform color coding on the status information of the matrix unit, and generate the visualization view, please refer to FIG. 10 and related descriptions thereof.

In some embodiments of the present disclosure, by generating the data structure of the construction progress matrix, it is possible to implement management of the project documents based on the matrix units, wherein related information of the project documents corresponding to the matrix units is centrally stored in a document directory, which improves a centralization and management efficiency of the project documents.

In some embodiments, the processor may: in response to detecting that the second project document is stored in the corresponding business database, determine a digital hash value of the second project document; invoke a smart contract of a blockchain network, package the digital hash value, the document tag, and a timestamp into a transaction, and send the transaction to the blockchain network for evidence preservation; and receive a transaction receipt returned by the blockchain network, and update a transaction hash in the transaction receipt into the second document directory as tamper-proof index information of the second project document.

In some embodiments, the processor may monitor the storage of the second project document in the business database in real time by the listener deployed on the business database. The listener may monitor the status change event of the second project document, including insertion or update operations, or the like.

The digital hash value refers to a fixed-length string generated by determining input data using a hash function. The digital hash value may be used to uniquely identify the input second project document.

In some embodiments, by using the hash function, the processor maps data corresponding to the second project document to relatively short data, to identify the uniqueness of the input second project document. The processor determines the digital hash value of the second project document by executing the hash function on complete content of the second project document stored in the business database. The hash function may include a plurality of hash algorithms, for example, a secure hash algorithm 256-bit (SHA-256 algorithm), an SM3 cryptographic hash algorithm, a message digest algorithm 5 (MD5 algorithm), a Blake2b algorithm, or the like.

The blockchain network refers to a decentralized, distributed, and tamper-proof digital ledger system that stores data blocks in a chain using cryptographic technology. For example, the blockchain network may be a public chain, a consortium chain, or a private chain built based on protocols such as Ethereum, Hyperledger Fabric, or Bitcoin.

The smart contract of the blockchain network refers to program code deployed on the blockchain network that may automatically execute preset rules and terms. For example, the smart contract of the blockchain network may be a pre-deployed contract for data evidence preservation, which includes functions for recording the digital hash value and the related information, or the like.

The transaction refers to a data package that records specific operations (for example, data evidence preservation, asset transfer, or smart contract invocation) in the blockchain network. For example, the transaction may include the digital hash value, the document tag, and the timestamp, for evidence preservation on the blockchain network.

In some embodiments, the processor may invoke the smart contract of the blockchain network to combine the digital hash value of the second project document, the document tag of the second project document, and a current timestamp obtained from a system clock into a structured data package (i.e., packaged into the transaction), to perform construction of the data package. For example, the processor may construct an object of a lightweight data exchange format (JavaScript Object Notation, JSON), which includes a hash value field, a document tag field, and a timestamp field.

In some embodiments, the processor performs invocation of the smart contract by invoking an evidence preservation method for evidence preservation smart contract pre-deployed on the blockchain network through a blockchain node interface. The evidence preservation method for evidence preservation smart contract refers to a method in the smart contract of the blockchain network for implementing a data evidence preservation function. For example, the evidence preservation method may receive the digital hash value, the document tag, and the timestamp of the document as input, and write the input information into the blockchain to provide tamper-proof credentials. For example, the processor may interact with an Ethereum-compatible blockchain network through a Web3.js library and invoke a “storeProof” function of the smart contract. For example, the processor may also interact with a Hyperledger Fabric network or the like through a Fabric SDK and invoke a related evidence preservation function defined in the chaincode.

In some embodiments, the processor may send a packaged transaction to the blockchain network for evidence preservation. For example, the processor may digitally sign the transaction using a pre-configured blockchain account private key to ensure authenticity of the transaction identity, and broadcast the signed transaction to a blockchain network node to perform transaction signing and sending.

The transaction receipt refers to a record credential returned to a transaction initiator by the blockchain network after processing a transaction, which includes detailed information of the transaction. For example, the transaction receipt usually includes information such as a transaction hash, a block number, a transaction sender, a transaction receiver, a transaction status (for example, “success” or “failure”), and a consumed Gas amount.

The transaction hash in the transaction receipt refers to information containing a unique identifier of the transaction, returned by the blockchain network after processing and confirming the transaction. For example, the transaction hash in the transaction receipt is a unique identifier of the transaction on the blockchain, which may be used to query transaction details on the blockchain, and may be updated into the document directory as the tamper-proof index information.

The tamper-proof index information refers to identification information used to verify data integrity and untampered nature of related data. The tamper-proof index information may be traced back to a corresponding unchangeable external record. For example, the tamper-proof index information may be the transaction hash of the blockchain network. Through the transaction hash, a corresponding evidence preservation record may be queried on the blockchain network, thereby verifying the originality and untampered nature of the document.

In some embodiments, the processor may extract key fields from the transaction receipt returned by the blockchain network node, to perform transaction receipt processing. For example, when the processor receives the transaction receipt, it parses a JSON structure thereof, extracts a “transactionHash” field, and obtains the transaction hash.

In some embodiments, the processor updates the transaction hash as a tamper-proof evidence preservation credential into the second document directory of the business database (i.e., a record field corresponding to the second project document), establishes a bidirectional association between an off-chain document and an on-chain evidence preservation, to establish the tamper-proof index information of the second project document. For example, in a database table of the second document directory, a “blockchain_tx_hash” field is added for each second project document, and a received transaction hash is written into the field.

In some embodiments, if the transaction receipt indicates a transaction failure, the processor records an error log and triggers a retry mechanism or an alarm notification, to perform fault-tolerant processing. For example, the processor may set a scheduled task to retry evidence preservation for the documents with the transaction failure.

In some embodiments of the present disclosure, by packaging the digital hash value, the document tag, and the timestamp of the second project document into the transaction for evidence preservation, and using the transaction hash as the tamper-proof index information, reliable document tamper-proofing and traceability mechanism are provided. This significantly enhances the security and credibility of the system in processing project documents, effectively avoids a risk of the documents being illegally tampered with or repudiated, and provides a solid trust basis for project management.

In some embodiments, the processor may obtain text content of the second project document; extract, based on the text content, at least one semantic feature vector by a processing model; determine, based on the at least one semantic feature vector and the progress node data of the target matrix unit, a progress delay probability of the target matrix unit by a progress prediction model; and perform, in response to the progress delay probability exceeding a preset threshold, a risk warning annotation on the target matrix unit.

In some embodiments, the processor may perform format parsing (for example, scanning, etc.) on the second project document through a document parsing engine; process image content (for example, scanned documents) in the parsed second project document using optical character recognition technology, or the like, and convert the image content into machine-readable text data; and preprocess the extracted raw text data to form standardized text content and determine the standardized text content as the text content of the second project document. The preprocessing includes removing special characters, stop word filtering, text normalization, or the like.

The processing model refers to a model used for extracting the semantic feature vectors. In some embodiments, the processing model is a machine learning model. For example, the processing model may be any one or a combination of a pre-trained natural language processing model, or other customized model structures or the like.

In some embodiments, the processor may select a language representation model pre-trained with a large-scale corpus as the processing model, and load parameters and a vocabulary of the processing model. The processing model may be a BERT model, a RoBERTa model, or an ERNIE model, or the like.

The semantic feature vector refers to a numerical vector used for representing semantic information of the text content. For example, the semantic feature vector may be a word vector (such as word vectors generated by Word2Vec or GloVe) or a document vector (such as a vector representation corresponding to a “CLS” token of a BERT model), or the like.

In some embodiments, the processor may input the text content of the second project document into the processing model, and perform deep semantic encoding through a multi-layer transformer structure of the processing model; extract a vector representation corresponding to the “CLS” token from a last hidden state of the processing model, and use it as the semantic feature vector of the second project document; or perform a mean pooling operation, or the like, on all word vectors in the text content to generate a fixed-dimension document-level semantic feature vector as the semantic feature vector of the text content of the second project document.

In some embodiments, the processor may also extract the semantic feature vector through other types of machine learning models. For example, the processing model may be Word2Vec or GloVe word embedding models or the like, and combined with pooling operations, or use recurrent neural network models such as long short-term memory (LSTM), gated recurrent unit (GRU), or the like, to extract semantic representations of the text.

The progress prediction model refers to a model used for predicting the progress delay probability. In some embodiments, the progress prediction model is a machine learning model.

In some embodiments, input of the progress prediction model includes the semantic feature vector and the progress node data of the target matrix unit, and output of the progress prediction model includes the progress delay probability of the target matrix unit.

The progress delay probability refers to an estimated probability that the target project unit is completed within a predetermined time. For example, the progress delay probability may be a numerical value between 0 and 1, a higher numerical value indicates a greater possibility of delay.

In some embodiments, the progress prediction model includes a feature fusion layer, configured to perform feature alignment and concatenation on the semantic feature vector and the progress node data, to form a fused feature representation. For example, the processor may perform vector concatenation on the semantic feature vector and numerical features such as the construction time and a completion percentage of the target matrix unit.

In some embodiments, the progress prediction model adopts a deep neural network structure. For example, the progress prediction model may use a multi-layer perceptron (MLP), which includes a plurality of fully connected layers, to learn nonlinear relationships between complex features. As another example, the progress prediction model may also adopt a gradient boosting decision tree (GBDT) model, such as XGBoost or LightGBM, for predicting the delay probability.

In some embodiments, a training process of the progress prediction model uses historical project documents and actual progress results thereof to form a training sample set, and optimizes model parameters through a backpropagation algorithm, for example, by minimizing a binary cross-entropy loss function.

In some embodiments, the progress prediction model may be trained and obtained based on training data. In some embodiments, the processor may obtain a training sample set composed of a plurality of labeled training samples, and perform a plurality of iterations based on the training sample set.

Each training sample may include a sample semantic feature vector and progress node data of a sample target matrix unit. The label is the progress delay probability of the sample target matrix unit corresponding to the training sample. The training samples may be constructed based on a plurality of historical project documents and actual progress results corresponding to the plurality of historical project documents. The label may be determined based on whether there is a progress delay in the target matrix unit corresponding to the training sample, among the plurality of historical project documents.

In some embodiments, the processor may input the training sample set into an initial progress prediction model to perform a plurality of rounds of iteration. Each round of iteration includes: selecting one or more training samples from the training sample set; inputting the one or more training samples into the initial progress prediction model to obtain model prediction outputs corresponding to the one or more training samples; substituting the model prediction outputs corresponding to the one or more training samples, and the labels of the one or more training samples, into a formula of a pre-defined loss function to determine a value of the loss function; and iteratively updating the model parameters in the initial progress prediction model based on the value of the loss function (for example, optimizing the model parameters through the back-propagation algorithm and minimizing the binary cross-entropy loss function), until an iteration termination condition is satisfied, the iteration is terminated, thereby obtaining a trained progress prediction model. The iteration termination condition may include convergence of the loss function, a count of iterations reaching a threshold, or the like.

In some embodiments, determining the progress delay probability may also be implemented through a plurality of other machine learning models, for example, classification models such as support vector machine (SVM), random forest, logistic regression, or ensemble learning manners, to predict the progress delay probability.

The risk warning annotation refers to an identification or prompting operation performed on matrix units of a related project when a potential risk is detected. For example, the risk warning annotation may manifest as a color change, a warning icon, or a text prompt on a user interface, or as triggering an automatically sent warning notification (e.g., email, message).

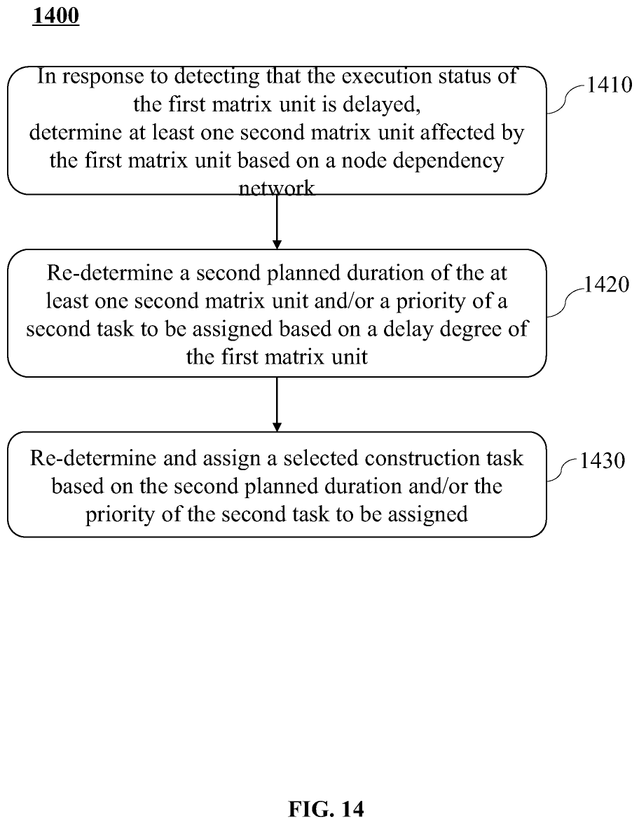

In some embodiments, the processor may compare the progress delay probability with the preset threshold. The preset threshold may be set manually or based on experience. For example, when the preset threshold is 0.6, and the progress delay probability is 0.7, the processor may trigger the risk warning annotation. The risk warning annotation on the target matrix unit may be visually prompted on the user interface by changing the display color of the target matrix unit, adding a conspicuous icon, or displaying the warning text. For example, the risk warning annotation may include generating and sending a warning notification, or updating the task status in the system for project management, generating a risk report, or integrating risk information into other decision support systems. In some embodiments, the risk warning annotation may also be coordinated with a disposal operation or a warning and task assignment function for subsequent matrix units. For more details about the disposal operation and the warning and task assignment function of the matrix units, please refer to FIGS. 5 and 14 and related descriptions thereof.

In some embodiments, in response to the progress delay probability not exceeding the preset threshold, the processor does not perform an operation and does not trigger the risk warning annotation.

In some embodiments of the present disclosure, by obtaining the text content of the second project document and extracting at least one semantic feature vector by the processing model, combined with the progress node data, the progress prediction model may accurately determine the progress delay probability of the target matrix unit. In response to performing the risk warning annotation for a high delay probability, traditional document management may be elevated to an intelligent risk prediction level, achieving proactive management and control of project progress and intelligent decision support, and effectively reducing a project delay risk.

In some embodiments, the processor may render, on a display device, a three-dimensional (3D) building information model of the target project; spatially bind the plurality of matrix units in the data structure of the construction progress matrix with building components in the 3D building information model; determine, in response to a selection operation from a user on a target component in the 3D building information model, a matrix unit corresponding to the target component from the data structure of the construction progress matrix, and invoke a second document directory associated with the matrix unit corresponding to the target component; and display, in a floating window of a graphical user interface (GUI), a document list in the second document directory.

The 3D building information model (BIM) is a digital building model that integrates information of the full project lifecycle, including geometric information, physical attributes, and functional attributes, or the like. The display device refers to a hardware device for presenting visual information, for example, a monitor of the terminal 130, a virtual reality/augmented reality headset, or the like. For more details about the terminal 130, please refer to FIG. 1 and related descriptions thereof.

In some embodiments, the processor may utilize BIM viewer software or a custom BIM rendering engine to parse BIM model files (for example, constructed based on the target project), and use a graphics API (for example, OpenGL, DirectX) to convert 3D geometric data, material and texture data into a pixel display on a screen. In some embodiments, the rendering process may also be implemented through a plurality of other 3D graphics rendering techniques and tools, for example, rendering using an API interface of CAD software, or performing high-performance rendering using a game engine.

The building component refers to an independent object in the 3D building information model that represents physical entities or logical components of a building. The building components include walls, columns, slabs, doors and windows, pipes, equipment, or the like.

In some embodiments, the spatial binding may be implemented through identifier (ID) matching. In the 3D building information model, each building component usually has a unique ID, and each matrix unit in the data structure of the construction progress matrix may also be associated with the ID(s) of one or more BIM components. The processor may traverse the data structure of the construction progress matrix and the 3D building information model, and match a matrix unit and a building component that have the same or associated IDs, thereby establishing a logical association between the two and implementing the spatial binding. For example, the binding may also be performed through attribute mapping. In some embodiments, the spatial binding may also be implemented through a plurality of other techniques, e.g., geometric position overlap detection, a rule-based automatic association algorithm, or user-manually specified binding relationships.

The target component refers to a specific building component designated by the user through an interactive operation in the 3D building information model. The interactive operation may include clicking, selecting, and so on.

The selection operation refers to an interactive behavior performed by the user on a specific object to designate or highlight the object. The interactive operation may serve as a selection operation, for example, clicking, selecting, or the like.

In some embodiments, the user may perform the selection operation by clicking on a building component on the rendered 3D building information model using a mouse. The BIM rendering engine captures a mouse click event, and identifies the clicked building component based on a projection of a click position in 3D space. For example, in a touch device or a virtual reality/augmented reality environment, the user may select the target component through touch, a gesture, or a ray selector.

In some embodiments, after receiving the ID of the selected target component, the processor utilizes the binding relationship of the spatial binding to perform a reverse lookup, and determines the matrix unit corresponding to the target component. After determining the matrix unit, the processor may query a database storing second document directory information, to obtain the second document directory. For example, in a database table of the second document directory, all document tag records associated with the ID of the matrix unit may be queried. For example, all the second project documents of the corresponding second document directory may also be obtained from the database based on the ID of the matrix unit.

The GUI refers to an interface on the terminal 130 that allows the user to interact with the terminal 130 through graphical icons, menus, buttons, and other visualization elements. The floating window refers to a usually small and movable window that dynamically pops up on the GUI, used for displaying additional information or providing temporary operations.

In some embodiments, the processor displays the floating window on the GUI. The floating window displays key information such as a document name, type, upload date, and status obtained from the second document directory in a list format (for example, a table or a scrollable list). For example, the document list may also be dynamically loaded and displayed in a sidebar or an information panel of the GUI, ensuring a smooth interactive experience with the 3D building information model.

In some embodiments of the present disclosure, by spatially binding the 3D building information model with the data structure of the construction progress matrix, the user is enabled to intuitively select building components in a 3D model, and immediately invoke and display the associated second document directory. Such an integration of 3D visualization and document management significantly improves a retrieval efficiency and ease of use of the project documents, and enhances an informatization level of the project management.

FIG. 5 is a flowchart illustrating an exemplary process for storing project documents according to some embodiments of the present disclosure.

As shown in FIG. 5, a process 500 includes the following operations. In some embodiments, the process 500 may be performed by a processor.

In 510, a data structure of a construction progress matrix corresponding to a target project is generated.

For more details about the operation 510, please refer to the operation 410 and related descriptions thereof.

In 520, a first document directory of the target project is generated based on feature values of project features of the target project.

For more details about the operation 520, please refer to the operation 420 and related descriptions thereof.

In 530, a second project document corresponding to the target matrix unit is screened out from a plurality of first project documents based on construction area tags and progress node tags of the plurality of first project documents, and a second document directory corresponding to the target matrix unit is generated.

For more details about the operation 530, please refer to the operation 430 and related descriptions thereof.

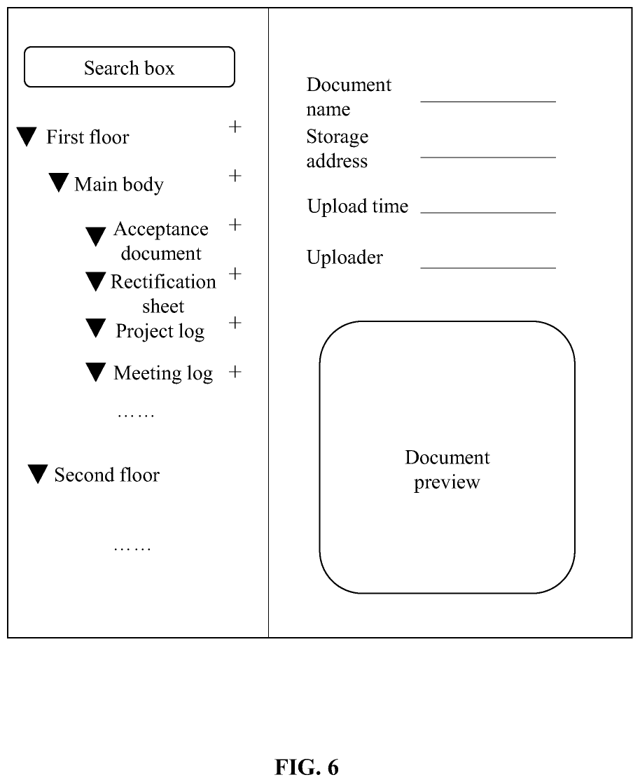

FIG. 6 is a schematic diagram illustrating an exemplary second document directory according to some embodiments of the present disclosure.

The second document directory may list a plurality of types of project documents corresponding to each target matrix unit. As shown in FIG. 6, a directory hierarchy structure on a left side of the second document directory displays project documents corresponding to each target matrix unit (i.e., each target construction area and its target progress node). In the directory hierarchy structure, a first-level directory is the construction area of the target matrix unit, such as “first floor”; a second-level directory is the progress node of the target matrix unit, such as “main body”; and a third-level directory is the second project documents corresponding to the target matrix unit, such as acceptance documents, rectification sheets, project logs, and meeting logs. The first-level directory and the second-level directory correspond to a matrix unit in a construction progress matrix.

By clicking on a project document in the second document directory, related information of the project document may be obtained. As shown in FIG. 6, a right side of the second document directory may display a project name, a storage address (i.e., index information), an upload time, an uploader, and a document preview of the second project document.

In some embodiments, each second project document corresponds to a construction task in the progress node of the target matrix unit, and second project documents in the second document directory may be sorted according to the time of construction tasks.

In some embodiments of the present disclosure, by means of the directory hierarchy structure of the second document directory, a hierarchical relationship in the construction progress matrix may be mapped, enabling management of the project documents to be expanded layer by layer according to construction area-progress node-construction document, thereby improving a query efficiency of the project documents.

In some embodiments, the processor may determine second project documents corresponding to the target matrix unit based on the construction area tags and the progress node tags of the first project documents, and then generate the second document directory storing related information of the second project documents. Specifically, the processor may screen out first project documents, whose construction area tags are the target construction area and whose progress node tags are the target progress node, from the first project documents of the first document directory, and use the screened-out first project documents as the second project documents. The second project documents may inherit the document tags of the first project documents. For example, the document tags that the second project documents may inherit include a basic information tag, a construction area tag, a progress node tag, a database tag, a warning rule tag, a disposal rule tag, an affiliated unit tag, a construction task tag, or the like. Next, the processor may generate the second document directory based on the document tags of the second project documents. Basic information such as the document name and the type in the second document directory may be determined based on the basic information tag, and the index information may be determined based on the database tag. For example, based on the database tag, a database where the second project document is stored may be determined, then an address or a link of the database may be used as the index information of the second project document.

In some embodiments, a user (such as project management personnel) may manually modify the second document directory generated by the processor through the terminal based on needs.

In 540, a business database corresponding to the second project document is monitored based on the database tag of the second project document, thereby a status change event of the second project document is monitored and corresponding index information in the second document directory is updated.

For more details about the operation 540, please refer to the operation 440 and related descriptions thereof.

In some embodiments, the document tag further includes a warning rule tag and a disposal rule tag. The process 500 further includes an operation 550 and an operation 560.

In 550, in response to detecting generation of the second project document, whether related data of the second project document complies with a warning rule is monitored based on the warning rule tag of the second project document.

In some embodiments, in response to detecting generation of the second project document, the processor may determine a warning rule of the second project document based on the warning rule tag of the second project document. The warning rule is configured to constrain a generation time of the related data of the second project document. The processor may obtain monitoring information related to the related data, and determine, based on the monitoring information, whether the related data complies with the warning rule; and implement, in response to determining that the related data does not comply with the warning rule, a corresponding disposal operation based on the disposal rule tag.

The warning rule defines a rule that the second project document and/or the related data thereof needs to satisfy, otherwise a warning may be triggered (such as sending a warning prompt to the user). For example, the warning rule is configured to constrain the generation time of the related data of the second project document. If the generation time of the related data of the second project document complies with the warning rule, the warning may not be triggered; otherwise, the warning may be triggered.

The related data refers to data associated with the second project document, and a form of expression of the related data may be project documents or other forms (such as user input data and instructions, or the like). Generally, performance of construction operations (such as construction task execution, construction task acceptance, and construction task supervision) needs to comply with specific project specifications. Specific relationships may exist among different construction operations, which also causes specific relationships to exist among data corresponding to different construction operations. The relationships among the data may be determined based on the project specifications, or may be specified by the user.

In some embodiments, the related data may include predecessor data and successor data. The predecessor data refers to data that needs to exist before the generation of the second project document. That is to say, the generation of the second project document may only be performed after the predecessor data exists. For example, the construction of a secondary structure may only be performed after an acceptance of a main structure of a first floor. Therefore, an acceptance sheet corresponding to the main structure of the first floor is the predecessor data for a construction log corresponding to the construction of the main structure of the second floor. The successor data refers to data that needs to be generated after the generation of the second project document. That is, prior to generation of subsequent data, there must be the generation of the second project document. For example, if concrete pouring is required after the concealed rebar acceptance, then the construction log corresponding to the concrete pouring is the post-requisite data of the acceptance sheet corresponding to the concealed rebar acceptance.

In some embodiments, the related data includes a third project document, among the plurality of first project documents, related to the second project document. That is, the related data also includes a project document related to the target project. The third project document may be a predecessor project document or a successor project document of the second project document. The construction area corresponding to the third project document may be the target construction area (that is, the second project document and the third project document correspond to the same construction area), or may be another construction area (that is, the second project document and the third project document correspond to different construction areas). The progress node corresponding to the third project document may be the target progress node (that is, the second project document and the third project document correspond to a same progress node), or may be another progress node (that is, the second project document and the third project document correspond to different progress nodes).

The generation time of the related data refers to a generation time point of the predecessor data or the successor data relative to the second project document. For example, the second project document may be the construction log. The warning rule stipulates that after the generation of the construction log, a supervisor approval document should be generated within 24 hours. In this case, the supervisor approval document serves as the successor data of the construction log, and “within 24 hours” is the generation time requirement for the successor data.

The processor may determine the warning rule of the second project document based on the warning rule tag of the second project document. The warning rule tag refers to a tag that identifies a warning rule associated with a project document. For example, the project management personnel may preset the warning rule tags for a plurality of types of project documents in the general document directory library. When the first project document is determined from the general document directory library, the warning rule tag is inherited from the general document directory library. When the second project document is determined, the warning rule tag is inherited from the first project document. The processor may determine the warning rule based on the warning rule tag of the second project document. In some embodiments, the project management personnel may also modify the warning rule of the second project document through a terminal according to requirements, to adapt to actual needs of different projects.

Further, the processor may obtain the monitoring information related to the related data. The monitoring information refers to related information obtained by monitoring status changes of the related data. For example, the monitoring information includes generation, modification, and deletion of the related data, a generation timestamp, a modification timestamp, or the like. In some embodiments, the processor may obtain the monitoring information in a plurality of manners. For example, the processor may obtain the monitoring information based on log records of the related data. The log records may include historical records of user operations on the related data, upload records of the related data, status changes of the related data, and other information.

In some embodiments, when the related data includes the third project document, the monitoring information related to the third project document may be obtained based on the database tag of the third project document. For example, the processor may determine the storage database of the third project document based on the database tag of the third project document, and utilize a listener to monitor the storage database for the third project document, so as to obtain the monitoring information related to the third project document.

The processor may determine, based on the monitoring information, whether the related data complies with the warning rule. For example, the warning rule is that after the generation of the second project document, the successor data should be generated within 24 hours. If the monitoring information of the successor data indicates that the generation time exceeds 24 hours, then the successor data does not comply with the warning rule.

When the related data does not comply with the warning rule, an operation 560 may be executed.

In 560, a corresponding disposal operation is implemented based on the disposal rule tag corresponding to the second project document.

The disposal operation refers to measures that should be taken when the related data does not comply with the warning rule. For example, the disposal operation includes sending messages, intercepting data, intercepting a process, revoking permissions, or the like. Sending messages refers to sending a warning notification to relevant users of the related data. Sending messages refers to sending a warning prompt or an operation notification to the corresponding responsible unit based on the affiliated unit tag carried by the related data. Intercepting documents refers to prohibiting related data that does not comply with the warning rule from performing operations such as creation, upload, or approval, to ensure that the precedent and subsequent dependency relationship of the process is maintained. Intercepting a process refers to pausing or stopping the related data from performing operations such as creation, upload, or approval until the related data complies with the warning rule. Revoking permissions refers to temporarily restricting or revoking specific operation permissions of the relevant responsible unit based on the affiliated unit tag of the related data, to prevent further non-compliant operations.

The disposal rule tag refers to a tag that identifies a disposal rule associated with a project document. The determination manner of the disposal rule tag is similar to that of the warning rule tag described in the operation 550, and thus may not be elaborated here.

In some embodiments, the document tag further includes an affiliated unit tag. When the related data includes the third project document, implementing the corresponding disposal operation based on the disposal rule tag further includes: sending, based on the affiliated unit tag of the third project document, a notification to an affiliated unit corresponding to the third project document.

The affiliated unit refers to a unit that has a direct or indirect relationship with the construction area and the progress node of the project during the project construction process. For example, the affiliated unit may include a construction entity, a design unit, a supervision unit, and so on. In some embodiments, different affiliated units undertake different project document management responsibilities. For example, the construction entity is responsible for submitting construction logs, quality acceptance sheets, and other project documents; the supervision unit is responsible for submitting acceptance sheets, supervision logs, and other project documents; and the design unit is responsible for submitting technical disclosures, construction change documents, and other project documents.

The affiliated unit tag is used to identify a construction entity associated with a project document. The determination manner of the affiliated unit tag is similar to that of the warning rule tag described in the operation 550, and thus may not be elaborated here.

In some embodiments, the processor may determine the affiliated unit of the third project document by identifying the affiliated unit tag of the third project document. When the disposal rule tag indicates that the disposal operation corresponding to the third project document includes sending messages, the processor may send the notification to the determined affiliated unit.

In some embodiments of the present disclosure, based on the warning rule tag of the second project document, monitoring and compliance assessment of the related data may be realized, to ensure that the related data is submitted within a specified time, and to avoid construction task progress delay caused by delay of the related data. In this manner, project supervision and progress advancement may be achieved based on document management, to enable documents to perform other functions beyond information recording.

Furthermore, since a construction project often involves a plurality of responsible units, upload and rectification of documents require collaborative work from the plurality of responsible units. When the related data is the third project document, based on the affiliated unit tag of the third project document, the affiliated unit may be quickly identified and a notification may be sent. Thereby, the manual communication cost among the plurality of units may be reduced, the automation level of project document management may be improved, and efficient circulation of documents among the plurality of responsible units may be ensured.

In some embodiments of the present disclosure, by generating the construction progress matrix corresponding to the target project, document management based on the target matrix unit may be achieved, the related information of the second project document corresponding to the target matrix unit is centrally stored in the second document directory, so that the second project document may be managed in a structured manner. The second project document itself is stored in the corresponding database. A storage path of the second project document may change due to reasons such as database migration, file renaming, or version updates. By a listener monitoring the database corresponding to the second project document based on the database tag, status changes of the second project document may be automatically detected, and index information is updated in real time. This ensures that the project document status is always synchronized with the construction progress, avoids lag or errors caused by manual index maintenance, ensures that the user may access the latest version of project documents, and improves an intelligence level of construction management.

On the other hand, compared with a traditional file management method, the document management method in the present disclosure may establish a logical mapping between project documents and construction areas and progress nodes, thereby making the association between the project documents and construction business closer. Since construction business is a hub for mutual cooperation among various functional units, when the association between project documents and construction business is closer, the project documents and functional departments may also generate a closer association. Thus, project documents may play a greater role (such as compliance determination, warning and disposal, or the like).

FIG. 7 is a schematic diagram illustrating an exemplary process for determining first project documents and generating a first document directory according to some embodiments of the present disclosure.

As shown in FIG. 7, the processor may query a general document directory library 720 for matching candidate project documents 730 based on feature values 710 of project features of a target project; and based on the candidate project documents 730, determine first project documents 740 corresponding to the target project and generate a first document directory 750.

For more details about the general document directory library and the reference values of project features, please refer to the operation 420 and related descriptions thereof.

In some embodiments, the general document directory library is configured to store a correspondence between reference values of project features and a plurality of types of project documents, and a document tag of each type of project document.

The reference values do not belong to a specific project, but rather are a general and fixed mapping relationship between document types and project features. The reference values may typically be defined by industry experience or historical data. In the general document directory library, the processor records the correspondence between each project document and the reference values. For example, if the project document is a rebar concealment acceptance sheet, then the reference value for engineering type is applicable to residential building projects, and the reference value for region is applicable to Guangdong Province. The processor may match the reference values in the general document directory library based on the feature values of the target project, thereby screening out candidate project documents suitable for the construction project.

The correspondence between the project documents refers to displaying documents corresponding to different engineering types and different regions in the general document directory library based on the reference values. For example, the correspondence may be documents corresponding to Sichuan residential building projects, documents corresponding to Guangdong airport projects, or the like.

In some embodiments, the general document directory library may be constructed by a user. In some embodiments, the general document directory library may be obtained through statistical analysis of historical data of projects. For example, as shown in FIG. 7, the general document directory library may be constructed by: obtaining sample document directories 721 of a plurality of sample projects and feature values 722 of project features of each of the plurality of sample projects; determining, based on the sample document directories, a distribution 723 of feature values of project features corresponding to each type of project document; and determining, based on the distribution of the feature values, reference values 724 of the project features corresponding to each type of project document.

The sample projects may be determined based on historical data. For example, the plurality of sample projects may be determined from a plurality of historical construction projects, and are used to generate the general document directory library.

The sample document directory refers to a document directory corresponding to a sample project, which stores related information of sample documents involved in the sample project. In some embodiments, the processor may obtain all historical documents of the sample project as sample documents, and generate a sample document directory based on related information of the sample documents (e.g., a document name, a document generation time, a document uploader, and a document type).

In some embodiments, the sample document directory includes a filing project document directory and a project management document directory. The sample documents involved in the filing project document directory (also referred to as filing project documents) are project documents required to be filed by government or construction project industry regulations, for example, process acceptance documents, sub-project acceptance documents, supervision logs, casting orders, or the like. In some embodiments, the filing project document directory records a hierarchical division of directories for the filing project documents, for example, a first-level directory is an engineering type, a second-level directory is a document type, or the like.

The sample documents involved in the project management document directory (also referred to as project management documents) are documents used for internal management by participants of the sample project, for example, including meeting records and construction daily reports of the sample project, or the like.

In some embodiments, a storage format of the filing project documents in the filing project document directory is [a document type, a region, an engineering type, a filing requirement], and a storage format of the project management documents in the project management document directory is [a document type, a region, an engineering type, a construction unit, a construction contractor].

In some embodiments, the processor may obtain filing document entries and compilation requirements of different regions and different engineering types based on government regulations, industry standards, industry databases, or the like, from various regions; construct the filing project document directory based on the filing document entries and the compilation requirements; obtain historical document data of the sample projects, and accordingly construct the project management document directory; and merge and deduplicate the filing project document directory and the project management document directory to determine the sample document directory. The user (e.g., the project management personnel) may manually adjust the sample document directory based on actual needs.

In some embodiments, the processor may identify the storage format of the project management documents to obtain the feature values of project features of the sample projects. For example, if the storage format of project management documents used by a sample project is [the document type, the region, the engineering type, the construction unit, the construction contractor], then the processor may parse the storage format and extract the feature values corresponding to the region, the engineering type, the construction unit, and the construction contractor of the sample project (i.e., the feature values of the respective project features).

For each type of project document, the distribution of feature values of project features corresponding to the type of project document may be determined based on the sample document directory. The distribution of feature values may reflect an occurrence frequency of the respective feature values of the sample projects storing the type of project document (also referred to as the document type).

Specifically, the processor may count the occurrence frequency of each document type under different feature values based on the sample document directory, thereby determining the distribution of feature values of project features corresponding to each type of project document. For example, for an acceptance document, the processor may count an occurrence frequency of the acceptance document in sample projects of different regions, an occurrence frequency of the acceptance documents in sample projects of different engineering types, an occurrence frequency of the acceptance document in sample projects of different construction units, an occurrence frequency of the acceptance document in sample projects of different construction contractors, or the like, thereby determining the distribution of feature values of project features corresponding to the acceptance document. Taking region as an example, if the occurrence frequencies of the acceptance document in the sample projects in Sichuan, Guangdong, and Hangzhou are A, B, and C, respectively, then the distribution of feature values of the project feature of region corresponding thereto is A, B, and C.

In some embodiments, for a plurality of types of project documents, the processor may, based on a first frequency threshold and the distribution of feature values thereof, screen out one or more feature values whose occurrence frequency is higher than the first frequency threshold as reference values. The first frequency threshold may be preset by the user based on needs, or may be determined based on a total occurrence count of the plurality of types of project documents (e.g., the first frequency threshold may be 20% of the total occurrence count). Continuing the above example, assuming that occurrence frequencies A and B exceed the first frequency threshold and the occurrence frequency C is less than the first frequency threshold, then Sichuan and Guangzhou may be used as reference values, and Hangzhou may be excluded.

In some embodiments, if the project document is a filing document required to be filed by government or construction industry, then even if the occurrence frequency of project features corresponding to the project document is lower than the first frequency threshold, the project document can not be excluded.

In some embodiments of the present disclosure, by establishing the general document directory library, a data basis may be provided for document management of various construction projects, enabling all construction projects to follow a unified document management standard, and ensuring consistency in project document management. In the construction process of the general document directory library, by statistically determining the distribution of feature values and determining high-frequency feature values as reference values, the most common feature values may be retained for generating the first document directory, to avoid the influence of casually occurring feature values. At the same time, filing documents that are mandatorily filed may not be erroneously excluded due to low frequency, thereby ensuring compliance in project document management, preventing omission of filing documents required by government or industry, and making the construction of the general document directory library more consistent with the general conditions of the actual construction industry.

The candidate project documents refer to project documents that match the target project in the general document directory library. In some embodiments, the processor may, based on the reference values of the project features corresponding to each type of project document in the general document directory library, screen out project documents whose feature values are the same as the feature values of the target project, as candidate project documents. For example, if the reference values of a document are the same as the feature values of project features of the target project, then the document may be a candidate project document. Continuing the above example, if the region to which the target project belongs is Sichuan, and the reference values for the regions corresponding to the acceptance documents in the general document directory library include Sichuan, then the acceptance documents may be selected as candidate project documents; if the region to which the target project belongs is Nanjing, and the reference values for the regions corresponding to the acceptance documents in the general document directory library do not include Nanjing, then the acceptance documents may not be selected as candidate project documents.

In some embodiments, the processor may directly use the candidate project documents as the first project documents corresponding to the target project, and generate the first document directory. In some embodiments, the processor may screen out the candidate project documents to determine the first project documents, and generate the first document directory. For example, the occurrence frequencies of the candidate project documents in sample projects may be determined, and a candidate project document with an occurrence frequency less than a second frequency threshold may be eliminated. The second frequency threshold may be preset according to requirements. The user may manually adjust the first project documents according to actual requirements. After determining the first project documents, related information of the first project documents in the general document directory library (such as document tags) may be inherited and stored into the first document directory.

In some embodiments of the present disclosure, there are a plurality of types of construction projects, and different engineering types (such as housing construction and municipal engineering) require different documents. By matching the candidate project documents from the general document directory library based on the feature values of project features of the target project, then screening the candidate project documents, and finally generating the first document directory, the first project documents may be complete and meet the requirements of the target project, and the influence of low-frequency project documents may be avoided. Meanwhile, the user may manually adjust the first project documents to meet personalized requirements without affecting project document management.

FIG. 8 is a flowchart illustrating an exemplary process for managing construction progress based on an updated second project document according to some embodiments of the present disclosure.

In some embodiments, a process 800 may be executed by a processor. In some embodiments, the process 800 may be executed after the operation 440.

For example, as various construction operations are performed in the target project, the corresponding second project documents may be generated or updated, and status changes may cause an update of index information in the second document directory. Due to the association between construction operations and the second project documents, the updated second document directory may reflect changes in the construction progress of the target project. Therefore, construction progress management may be performed based on the updated second document directory.

In 810, whether the target progress node corresponding to the target matrix unit satisfies a progress node update condition is determined based on the updated second document directory.

The target progress node refers to a progress node corresponding to the target matrix unit.

The progress node update condition refers to a predecessor condition that the target progress node needs to satisfy in the target project to advance to the next progress node.

In some embodiments, the progress node update condition includes a specific number (such as all) of the second project documents corresponding to the target progress node, or one or more specific second project documents (such as acceptance documents) having been uploaded. For example, when the target progress node is the main structure of the first floor, the progress node update condition includes the acceptance documents of the main structure having been uploaded.

As described in the operation 440, when a status of the second project document changes, index information in the updated second document directory may be generated. The processor may determine, based on the index information in the updated second document directory, whether the target progress node satisfies the progress node update condition.

In 820, in response to determining that the target progress node satisfies the progress node update condition, an associated matrix unit associated with the target matrix unit is determined based on relationship information related to the construction progress matrix.

The associated matrix unit refers to other matrix units that are associated with the target matrix unit. In some embodiments, there may be one or more associated matrix units. The other matrix units and the target matrix unit may correspond to the same or different construction areas. That is, the associated matrix units may be located in the same row (or column) of the construction progress matrix, or may be located in different rows (or columns) of the construction progress matrix.

The relationship information is used to reflect the relationship between different matrix units in the construction progress matrix. Sequential dependency relationships exist between progress nodes and construction areas of different matrix units in the construction progress matrix, including but not limited to a progress node dependency relationship and a construction area influence relationship. Illustratively, the progress node dependency relationship may be that after a certain progress node is completed, other related progress nodes may be executed. For example, the construction tasks in the main structure must be completed before the construction tasks of mechanical and electrical pre-embedding are performed. The construction area influence relationship may be that a certain construction area may affect the progress of other construction areas, for example, upper-layer construction needs to wait for lower-layer completion.

The relationship information may be determined in a plurality of manners. For example, the relationship information may be determined based on disclosure documents such as a construction plan of the target project. As another example, the relationship information may be manually entered by the user through a terminal device.

The processor may determine the associated matrix unit associated with the target matrix unit based on the relationship information of the target matrix unit. For example, in response to determining that the target progress node satisfies the progress node update condition, the processor may retrieve the construction progress matrix based on the relationship information to determine the associated matrix unit affected by the target matrix unit.

In 830, a construction notification is sent to a target affiliated unit of the associated matrix unit.

The target affiliated unit refers to an affiliated unit corresponding to the associated matrix unit. The target affiliated unit may be determined based on a correspondence relationship between respective matrix units in the construction progress matrix and participating units of the target project. The processor may send the construction notification to a terminal of a person in charge of the target affiliated unit. The construction notification is used to notify that a certain construction task at the target progress node has been completed and construction tasks of the associated matrix unit need to be started.

In some embodiments, the document tag further includes an affiliated unit tag and a construction task tag, and sending the construction notification to the target affiliated unit of the associated matrix unit includes: determining, based on construction area tags and progress node tags of a plurality of first project documents, fourth project documents corresponding to the associated matrix unit; determining, based on construction task tags of the fourth project documents, a target fourth project document, a construction time corresponding to the target fourth project document satisfying a first preset condition; and determining the target affiliated unit based on an affiliated unit tag of the target fourth project document, and sending the construction notification to the target affiliated unit.

The fourth project document refers to a document corresponding to the associated matrix unit. The processor may screen out, from the first project documents, project documents having the same construction area and progress node as the associated matrix unit based on the construction area tags and the progress node tags of the first project documents, and designate such project documents as the fourth project documents.

The target fourth project document refers to a project document that satisfies a preset condition among the fourth project documents. In some embodiments, the processor may determine the target fourth project document based on the construction task tags of the fourth project documents. The construction task tag refers to a tag identifying a construction task associated with a project document. The manner for determining the construction task tag is similar to that of the warning rule tag described in the operation 550, and thus may not be described in detail herein.

For example, for each fourth project document, the processor may determine, based on the construction task tag of the fourth project document, whether a construction time of a construction task corresponding to the fourth project document satisfies the first preset condition. If the first preset condition is satisfied, the processor determines the fourth project document as the target fourth project document. For example, the first preset condition may be that the construction time is within 7 days, or the construction time is among the first N construction tasks corresponding to all the fourth project documents. That is to say, when the related construction work for the associated matrix unit is initiated, the construction task corresponding to the target fourth project document (e.g., within 7 days) may be performed first.

Further, the processor may determine the target affiliated unit based on the affiliated unit tag of the target fourth project document, and send the construction notification to the target affiliated unit.

In some embodiments of the present disclosure, by screening out the target fourth project document that satisfies a construction time requirement based on the construction task tag, the construction notification may be preferentially sent to the target affiliated unit corresponding to earlier construction time, so as to ensure that the construction tasks are advanced as planned, reduce construction delays caused by project document delays, and improve the execution efficiency of the construction tasks. In addition, based on the affiliated unit tag, the target affiliated unit may be quickly and accurately determined, and the construction notification may be sent to the target affiliated unit, thereby ensuring that the submission and approval of the project documents are timely performed by the affiliated unit, reducing management loopholes caused by untimely manual notifications, and improving the intelligence level of project document management.

In some embodiments of the present disclosure, by determining whether the target progress node corresponding to the target matrix unit satisfies the progress node update condition based on the updated second document directory, the construction progress is ensured to be advanced as planned, and the construction efficiency is improved. Furthermore, by determining the associated matrix unit associated with the target matrix unit based on the relationship information related to the data structure of the construction progress matrix, and sending the construction notification to the target affiliated unit, orderly connection between different construction tasks may be ensured, breakpoints and resource waste of the construction tasks may be avoided, an overall construction collaboration efficiency may be improved, and changes in construction progress may be timely transmitted to the relevant responsible units. In the above manner, construction progress management based on project documents is realized, and the automation and efficiency of construction progress management are improved.

FIG. 9 is a schematic diagram illustrating an exemplary progress display table according to some embodiments of the present disclosure.

In some embodiments, the processor may generate a progress display table corresponding to a data structure of a construction progress matrix, and annotate a display cell corresponding to a target matrix unit in the progress display table. Specifically, the processor may determine progress information of the target matrix unit based on an updated second document directory. Based on the progress information, the processor annotates the display cell corresponding to the target matrix unit in the progress display table.

The progress display table is used for visually representing the construction progress of the construction areas and the progress nodes. As shown in FIG. 9, a progress display table 910 is a two-dimensional table, and the vertical axis displays the construction areas and the horizontal axis displays the progress nodes in the construction progress matrix. In some embodiments, the processor may generate the progress display table based on the construction areas and the progress nodes in the construction progress matrix. For example, based on the construction progress matrix, the processor uses the construction areas as rows and the progress nodes as columns to generate a table structure of the progress display table. For more details about the two-dimensional table, please refer to operation 1070 and related descriptions thereof.

The display cell refers to a basic unit of the progress display table. Each matrix unit in the construction progress matrix may correspond to a display cell in the progress display table. The processor may determine the corresponding display cell based on the construction area and the progress node of the target matrix unit.

The progress information reflects a completion status of a related construction task of the target matrix unit. For example, the progress information includes the status (“not started”, “in progress”, “completed”) of each construction task, a completion ratio of all construction tasks, or the like. The progress information may be determined based on the updated second document directory. For example, for each construction task, the processor may determine, based on the updated second document directory, whether an acceptance sheet for the construction task has been uploaded. If the acceptance sheet has been uploaded, the processor further obtains the acceptance sheet to confirm whether the construction task has passed acceptance. If acceptance is passed, the construction task is confirmed as completed. In some embodiments, the progress information may be in a percentage format, representing the completion ratio of all the construction tasks of the target matrix unit.

In some embodiments, the processor may annotate, based on the progress information, the display cell corresponding to the target matrix unit in the progress display table. For example, the processor may annotate the display cell corresponding to the target matrix unit using manners such as color annotation (for example, please refer to color coding in operation 1060), percentage annotation, and text annotation.

Illustratively, as shown in FIG. 9, a third color marking indicates that all the construction tasks are completed, a second color marking indicates that a portion of construction tasks are completed, and a first color marking indicates that all the construction tasks are not started. Percentages represent the completion ratio of all the construction tasks, where 100% indicates that all the construction tasks are completed, 50% indicates that half of the construction tasks are completed, and 0% indicates that all the construction tasks are not started, or the like.

In some embodiments of the present disclosure, by generating the progress display table corresponding to the data structure of the construction progress matrix and annotating the display cell corresponding to the target matrix unit in the progress display table, the user may intuitively view a construction progress status of the target project, which improves a visualization display effect of the construction progress. Furthermore, through the annotation of the display cells, the construction progress may be monitored in real time, thereby preventing delays in the construction progress.

FIG. 10 is a flowchart illustrating an exemplary process for assigning construction tasks based on visual progress according to some embodiments of the present disclosure.

As shown in FIG. 10, a process 1000 includes the following operations 1010-1070. In some embodiments, the process 1000 may be executed by a processor.

In 1010, a plurality of pieces of construction area data of a plurality of construction areas and a plurality of pieces of progress node data of a plurality of progress nodes of a target project are obtained.

For more details about the target project, the construction areas, construction area data, the progress nodes, and progress node data, please refer to the operation 410 and related descriptions thereof.

In some embodiments, the construction area may include a multi-level structure, that is, a hierarchical relationship exists among the plurality of construction areas, wherein a higher-level construction area includes one or more lower-level construction areas. For example, the target project may be divided into a plurality of individual buildings (e.g., “Building 1”, “Building 2”, or the like). Each individual building may further be divided into a plurality of floors, each floor may be divided into a plurality of dwelling units, and each dwelling unit may be divided into a plurality of functional rooms (e.g., “living room”, “bedroom”, or the like). Illustratively, in “living room of unit 201 on the 2nd floor of Building 1”, the “living room” construction area belongs to the immediately higher-level construction area “unit 201”. The “unit 201” construction area further belongs to the higher-level construction area “2nd floor”. The “2nd floor” then belongs to the “Building 1” construction area. This hierarchical subordination and inclusion relationship, jointly formed by “Building 1”, “2nd floor”, “unit 201”, and “living room”, illustrates the multi-level structure of the construction area. The processor may perform management and task assignment for construction areas at any one or more levels within the multi-level structure of the construction area.

In some embodiments, the plurality of construction areas of the target project may be obtained by parsing from a BIM or Computer-Aided Design (CAD) drawings, or may be manually divided and input by management personnel in the system 300 through a user terminal based on the needs of the target project.

In some embodiments, the construction area data may further include other attributes related to the management of the construction area, for example, at least one of a construction difficulty coefficient, a safety risk level, and a quality requirement level.

In some embodiments, the construction area data may be automatically extracted from files such as the BIM and the CAD drawings, or configured or inputted by a user in the system 300.

In some embodiments, when a design file is the BIM, the processor may extract the construction area data by parsing a data structure of the BIM. For example, the processor may directly read predefined attributes of each building component object in the BIM, for example, a component name (e.g., “load-bearing wall-1”), an associated floor (e.g., “F2”), and a room number (e.g., “R-201”), and combine such attribute information into the corresponding construction area data.

In some embodiments, when the design file is the CAD drawing, the processor may extract the construction area data by executing a graphic recognition and layer analysis algorithm. For example, the processor may identify a region formed by closed polylines in the CAD drawing, and, in combination with a name of a layer where the region is located (e.g., a layer name is “ROOM_BOUNDARY”) and text annotations within the layer (e.g., “living room”), determine a boundary and a name of a functional room construction area, thereby extracting the construction area data.

In some embodiments, each of the plurality of progress nodes includes a plurality of construction tasks having a construction order. For example, each progress node is not a single action, but includes a collection of a plurality of construction tasks having an inherent logical order (the construction order).

The construction task is a smallest work unit that constitutes a progress node. In some embodiments, each construction task corresponds to a real, executable construction operation. For example, in a progress node named “main structure engineering”, a plurality of construction tasks may be included, such as “rebar tying”, “formwork erection”, and “concrete pouring”.

The construction order refers to a sequential execution relationship between the plurality of construction tasks within the same progress node. For example, before concrete pouring, rebar tying and formwork erection must be completed first. In some embodiments, the construction order is a sequential execution relationship between the plurality of construction tasks that must be followed due to process requirements, technical specifications, or safety regulations.

In some embodiments, the progress nodes may be determined according to an industry standard process for construction (for example, based on sub-item engineering).

In some embodiments, the progress node data mainly includes a list of all construction tasks included in the progress node and the construction order that must be followed between these construction tasks.

In some embodiments, the progress node data may be obtained from a preset progress node template library. The progress node template library may predefine standardized progress nodes and internal construction tasks and logical relationships thereof according to different building types and industry specifications.

In some embodiments, the construction order may be predefined in the progress node template library and obtained together when obtaining the progress node data, or the construction order may be set through an industry standard process for construction.

In some embodiments, the processor may obtain specific construction tasks and logical relationships included in the progress node from an industry standard progress node template library. For example, a decoration and renovation engineering progress node may include a series of construction tasks having the construction order, such as “wall plastering”, “base leveling”, and “ceiling installation”.

In 1020, a plurality of matrix units are generated based on the plurality of pieces of construction area data and the plurality of pieces of progress node data.

In some embodiments, each matrix unit of the plurality of matrix units corresponds to a construction area of the plurality of construction areas and a progress node of the plurality of progress nodes.

The matrix unit refers to a management unit formed after uniquely binding a construction area with a progress node one by one.

In some embodiments, the matrix unit represents a set of phased construction tasks that need to be completed at a position of a specific construction area. For example, combining a construction area named “Building 3 Unit 2 Apartment 501” with a progress node named “Interior Fine Decoration” may generate a matrix unit, and the meaning of the matrix unit is “complete interior fine decoration engineering in Building 3 Unit 2 Apartment 501”. Correspondingly, the series of construction tasks having the construction order included in the progress node “Interior Decoration” may be executed in the construction area “Building 3 Unit 2 Apartment 501”.

In some embodiments, the processor may obtain the matrix units in a plurality of manners. In some embodiments, the processor may perform a Cartesian Combination on a set including a plurality of construction areas and a set including a plurality of progress nodes, that is, traverse and pair each construction area with a progress node to obtain a paired combination, and each paired combination may generate a corresponding matrix unit. Thus, a two-dimensional matrix structure may be constructed with the construction areas as the vertical coordinate and the progress nodes as the horizontal coordinate, and each cell in the matrix is a matrix unit.

In some embodiments, generating the plurality of matrix units based on the plurality of pieces of construction area data and the plurality of pieces of progress node data includes: performing a spatial conflict verification on a plurality of construction spaces required by the plurality of construction areas and the plurality of progress nodes; and, in response to spatial conflict verification of a plurality of target construction spaces among the plurality of construction spaces passing, generating the plurality of matrix units corresponding to a plurality of target construction areas and a plurality of target progress nodes corresponding to the plurality of target construction spaces.

The required construction space refers to a spatial attribute condition that must be satisfied to execute a matrix unit. In some embodiments, the required construction space may include inherent spatial information of a corresponding construction area and spatial requirements of a corresponding progress node for an application scenario. For example, for a construction area named “Building 1 Unit 1 Apartment 101”, its inherent spatial information may be defined as “indoor, first floor”; while for a progress node named “Roof Waterproofing Engineering”, its spatial requirements are “outdoor, top floor, horizontal plane”, or the like.

The processor may obtain the plurality of construction spaces required by the plurality of construction areas and the plurality of progress nodes in a plurality of manners. In some embodiments, spatial information of the construction area may be automatically parsed and extracted from geometric information and metadata included in the BIM or CAD drawings. For example, the processor may determine a floor where the construction area is located based on a floor elevation of the construction area in the BIM, and determine whether the construction area is indoor or outdoor based on a building component type of the construction area, or the like. In some embodiments, spatial requirements of the progress node may be predefined and stored as data in the progress node template library. For example, the spatial requirements corresponding to a “main structure” progress node in the progress node template library may be “all areas”, while the spatial requirements corresponding to a “landscape greening” progress node may be “outdoor”, or the like.

The spatial conflict verification refers to comparing and verifying spatial information of a construction area with spatial requirements of a progress node which are to be combined into a matrix unit, to determine whether there is a conflict or a mismatch between the construction area and the progress node.

In some embodiments, the spatial conflict verification may be further divided into a logical conflict verification and a physical conflict verification. The logical conflict verification refers to determining whether a combination of a construction area and a progress node may not be combined in terms of construction process, building function, or project management logic. For example, the processor may determine that a combination of applying a progress node “Foundation and Substructure Engineering” to a construction area “on the 5th floor” is not valid in terms of construction process logic, and thus there is a logical conflict. The physical conflict verification refers to determining whether a combination of a construction area and a progress node may not be combined in terms of actual physical spatial attributes of a building. For example, the processor may determine that a combination of applying a progress node “Interior Decoration” to a construction area of “an outdoor plaza” is a mismatch in terms of physical spatial attributes, and thus there is a physical conflict.

In some embodiments, a process of spatial conflict verification may include: extracting spatial information of a construction area and spatial requirements of a progress node which are to be combined into a matrix unit, and matching based on a preset verification rule. For example, the verification rule may include at least one of: when spatial requirements of a progress node include “outdoor”, spatial information of a matching construction area must also include “outdoor”, otherwise it is determined that there is a spatial conflict; when the spatial requirements of a progress node “Foundation and Substructure Engineering” are “first floor”, spatial information of a matching construction area must include “first floor”, otherwise it is determined that there is a logical conflict; and when spatial requirements of a progress node “Interior Decoration” are “indoor”, spatial information of a matching construction area must include “indoor”, otherwise it is determined that there is a physical conflict.

In some embodiments, for a combination of a construction area and a progress node, when its required construction space does not have a conflict under all verification rules, it is determined that spatial conflict verification for the combination passes. Conversely, if any verification rule is triggered and determined to be a conflict, then the spatial conflict verification for the combination fails.

In some embodiments, the processor may traverse and pair each construction area with a progress node to generate a plurality of candidate matrix unit combinations. The spatial conflict verification is performed on construction spaces of the plurality of candidate matrix unit combinations. In response to a construction space of a candidate matrix unit combination passing the spatial conflict verification, the processor determines the construction space of the candidate matrix unit combination as a target construction space. A corresponding matrix unit is simultaneously generated based on the construction area and the progress node corresponding to the target construction space (i.e., the construction area and the progress node in the candidate matrix unit combination corresponding to the target construction space). The matrix unit is created as a data object, and its interior includes a reference or an identification of the target construction area and the target progress node, thereby binding the two. Conversely, for a candidate matrix unit combination whose spatial conflict verification fails, the processor does not perform any generation operation, and determines the candidate matrix unit combination as an invalid combination and directly discards the candidate matrix unit combination.

In some embodiments of the present disclosure, by introducing a spatial conflict verification mechanism, significant beneficial effects may be achieved. On one hand, the accuracy and effectiveness of a project plan are ensured. The mechanism may filter out all logically or physically unexecutable combinations of construction areas and progress nodes at the source, ensuring that each generated matrix unit is meaningful and implementable, avoiding erroneous instructions from appearing in subsequent task dispatching stages, thereby improving the rigor of project management. On the other hand, the operational efficiency of the system is improved. By eliminating a large number of invalid combinations, the count of matrix units that need to be generated, stored, and processed is significantly reduced. This not only saves storage space of a database and computing resources of the system, but also accelerates the response speed of subsequent operations such as priority determination, data analysis, and visualization view rendering, optimizing the overall performance of the system.

In some embodiments, for each matrix unit, the processor performs the following operations 1030 to 1060:
In 1030, a first task to be assigned of the matrix unit is determined based on a difference set between a plurality of construction tasks and completed construction tasks of the matrix unit.

In some embodiments, the processor only performs construction task assignment for the matrix units that are currently in an idle state (without construction tasks being performed), and does not perform construction task assignment for the matrix units that currently have construction tasks being performed.

The difference set between a plurality of construction tasks and completed construction tasks refers to a collection of remaining, unassigned construction tasks, which is obtained by subtracting a collection of completed construction tasks within a construction area corresponding to a matrix unit that is in an idle state from a collection of all construction tasks included in a progress node corresponding to the matrix unit. For example, if a progress node includes three construction tasks: {“wall plastering”, “putty application”, “primer application”}, and the “wall plastering” task has been completed in the construction area corresponding to the progress node, then the difference set is {“putty application”, “primer application”}.

In some embodiments, the difference set may be obtained by querying status information of the plurality of construction tasks of the matrix unit pre-stored in a storage device of the system 300.

The first task to be assigned refers to a collection of one or more construction tasks that are to be performed next in the matrix unit, which are determined from the aforementioned difference set. In other words, the first task to be assigned is a collection of all “to-do” tasks within the matrix unit. For example, the remaining tasks to be performed {“putty application”, “primer application”} are the first task to be assigned of the matrix unit.

In 1040, a priority of the first task to be assigned is determined based on a weight coefficient of each matrix unit.

The weight coefficient refers to a numerical value used to characterize the relative importance or urgency of each matrix unit.

In some embodiments, the weight coefficient may be a specific numerical value (e.g., a value between 0 and 1), where the higher the value of the weight coefficient, the higher the priority of the matrix unit. For example, the weight coefficient (e.g., 0.9) of a matrix unit corresponding to a critical construction area may be significantly higher than that (e.g., 0.3) of a matrix unit corresponding to a non-critical construction area.

The processor may obtain the weight coefficient through a plurality of manners. In some embodiments, the processor may comprehensively consider a plurality of factors to obtain the weight coefficient, and the weight coefficient may be a normalized numerical value between 0 and 1. In some embodiments, the processor may comprehensively consider whether the progress node corresponding to the matrix unit is on the critical path of the project, a count of predecessor dependent tasks of the progress node, the importance of the construction area corresponding to the matrix unit (e.g., the importance of the “sample room” area is higher than that of the “equipment room” area), and a deviation degree between the actual progress and the planned progress of the matrix unit, or the like, to determine the weight coefficient.

For example, the processor may construct a project network diagram based on the basic logic among a plurality of progress nodes and an estimated duration for each progress node. Subsequently, the processor determines the earliest start time (ES) and the latest start time (LS) of each progress node by performing forward and backward determinations. When the earliest start time and the latest start time of a progress node are the same (i.e., ES=LS), it is determined that the progress node is on the critical path of the project. At this time, the processor assigns a higher value (for example, 1) to a critical path factor of the matrix units located on the critical path, and assigns a lower value (for example, 0) to the critical path factor of the matrix units located on a non-critical path.

As another example, the processor may determine a count of direct successor dependent tasks of each progress node as a predecessor node based on the aforementioned project network diagram; the larger the count, the stronger the hub nature of the progress node; the processor may perform normalization processing on the count (for example, by dividing it by the largest count of successor dependent tasks among all nodes), thereby obtaining a hub factor (between 0 and 1) of the matrix unit.

As yet another example, importance data of the construction area may be pre-set with an importance score for each construction area by the project management personnel through the user terminal during a project initialization stage according to project management requirements (for example, by setting areas such as “sample rooms” and “critical equipment rooms” as high importance). The processor directly obtains the pre-set importance score, and performs normalization processing on the pre-set importance score to use the importance pre-set score as the area importance factor of the matrix unit.

In some embodiments, the processor uses weighted summation to combine the aforementioned factors into a final weight coefficient. For example, the weight coefficient=(critical path factor×w1)+(hub factor×w2)+(area importance factor×w3), where, w1, w2, and w3 are pre-set weight parameters and may also be determined by user input. In this embodiment, it may be ensured that influence factors of different natures and dimensions are combined into a standardized and sortable weight coefficient value.

The priority refers to a level used to determine the order of precedence for assigning the first tasks to be assigned included in different matrix units.

In some embodiments, the priority of the first task to be assigned may be reflected by the numerical value of the weight coefficient of the matrix unit to which the first task to be assigned belongs, such that the matrix unit with a larger weight coefficient has a higher priority for the first task to be assigned within the matrix unit. For example, if the weight coefficient of matrix unit A is 0.95 and the weight coefficient of matrix unit B is 0.80, then the priority of the first task to be assigned in matrix unit A may be higher than the priority of the first task to be assigned in matrix unit B.

In addition, the construction tasks within each matrix unit inherently have a fixed construction order, which is used to determine the execution order of a plurality of first tasks to be assigned included within the same matrix unit. Therefore, the processor may comprehensively consider the priority and the construction order when determining the final sequence of first tasks to be assigned. Specifically, the processor first performs descending order sorting on all matrix units including the first tasks to be assigned based on the priorities among the matrix units. Then, the processor, according to a sorting result, sequentially selects the foremost construction task from each matrix unit according to the internal construction order of the construction tasks.

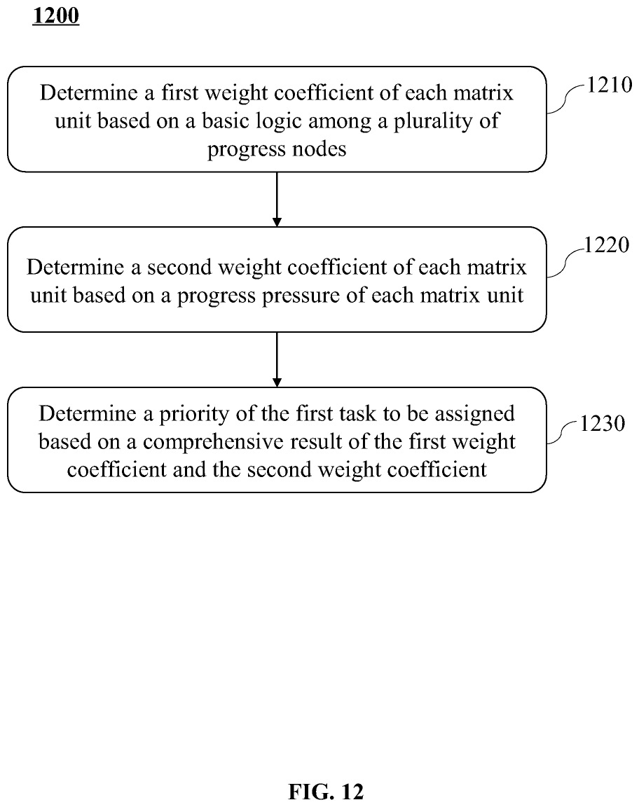

In some embodiments, the processor may also determine a first weight coefficient and a second weight coefficient of each matrix unit; and determine the priority of the first task to be assigned based on a comprehensive result of the first weight coefficient and the second weight coefficient. For more details, please refer to FIG. 12 and related descriptions thereof.

In 1050, a selected construction task is determined and assigned based on the priority of the first task to be assigned.

The selected construction task refers to a specific construction task selected from one or more first tasks to be assigned and prepared for distribution and execution. For example, if the processor determines, according to priority sorting, that the construction tasks in matrix unit A should currently be executed, and among the first tasks to be assigned of matrix unit A, “putty application” is the foremost according to the construction order, then the “putty application” task becomes a selected construction task.

In some embodiments, the processor may sequentially select start from the first tasks to be assigned included in the matrix unit with the highest priority and determine a selected first task to be assigned as the selected construction task for assignment.

In some embodiments, after the selection, the processor may further perform constraint verification of resources or environment, for example, by checking whether special equipment or construction teams required for executing the selected first task to be assigned are currently available, or the like. Only the first task to be assigned that has passed all verifications is finally determined as the selected construction task and enters an assignment process such as generating a construction task sheet for the selected construction task and distributing the construction task sheet to a performance entity, or the like. For more details about the performance entity, please refer to FIG. 5 and related descriptions thereof.

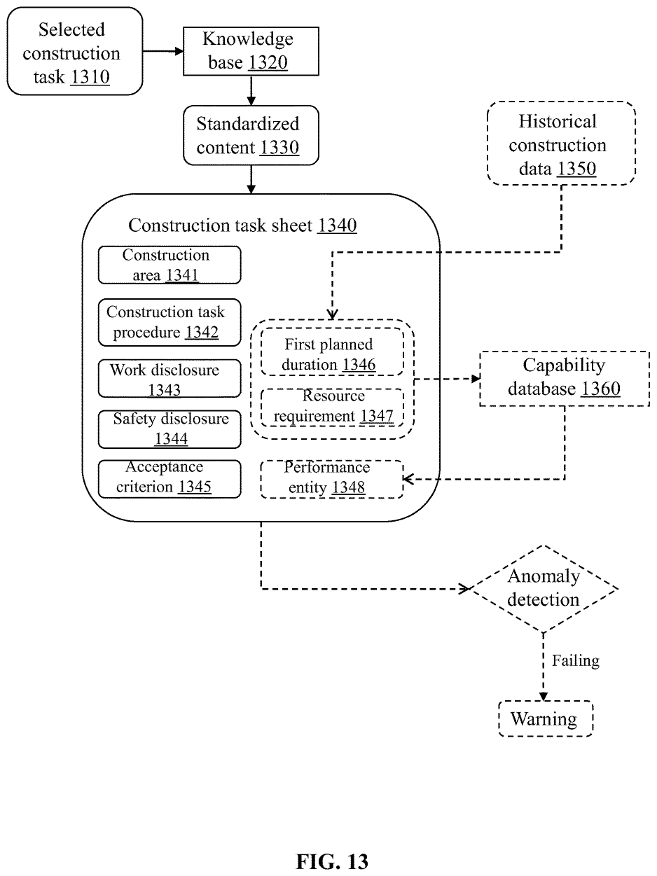

In some embodiments, the processor may also extract standardized content from a knowledge base based on the first tasks to be assigned, and generate a construction task sheet corresponding to each matrix unit. For more details, refer to FIG. 13 and related description thereof.

In 1060, status information of the matrix unit is updated, and color coding is performed on the status information based on an execution status of the selected construction task.

The execution status refers to actual progress of the selected construction task that has been assigned for execution at a construction site. In some embodiments, the execution status may include a plurality of stages, such as “not started”, “in progress”, “completed”, “delayed”, “acceptance qualified”, and “acceptance unqualified”. In some embodiments, the execution status may further include a progress percentage for each stage. For example, the execution status may be “in progress, 50%”. In some embodiments, the construction personnel may manually update and submit the execution status and the progress percentage of the construction task by operating the user terminal at different stages of task execution.

In some embodiments, in response to detecting that the execution status of the first matrix unit is delayed, the processor may further determine at least one second matrix unit affected by the first matrix unit for re-determination and re-assignment. For more details, please refer to FIG. 14 and related descriptions thereof.

In some embodiments, the processor may obtain the execution status by a plurality of manners. For example, the processor may obtain the execution status in real time through a “task probe” (for example, a mobile application operated by the construction personnel or an Internet of Things (IoT) sensor, or the like) deployed at the construction site. As another example, the execution status may be uploaded by the construction personnel or the management personnel through the user terminal.

The status information of the matrix unit refers to a comprehensive progress status of the matrix unit. In some embodiments, the status information is obtained based on a comprehensive evaluation of the execution status of all construction tasks included within the matrix unit (i.e., all construction tasks of the progress node corresponding to the matrix unit). For example, when all construction tasks within a matrix unit are not started, the status information of the matrix unit is “not started”; when at least one construction task is “in progress”, the status information is updated to “in progress”; and when all construction tasks are “acceptance qualified”, the status information is updated to “completed”.

The color coding refers to a mapping rule for performing visual representation on the status information of the matrix unit. In some embodiments, by presetting different colors for different pieces of status information, the progress may be intuitively displayed in the visualization view. For example, the color coding may be defined as: gray represents “not started”, yellow represents “in progress”, green represents “completed”, and red represents “delayed”.

In some embodiments, the processor may perform real-time monitoring on the execution status of any selected construction task that has been assigned for execution. When a change in the execution status is detected (for example, when a construction team marks the task status of the construction task from “in progress” to “completed” on the user terminal, or updates the progress percentage of the construction task), the processor may automatically perform one more operations including: positioning the matrix unit to which the construction task belongs, and re-determining and updating the status information of the matrix unit based on the latest execution status of all construction tasks within the matrix unit; updating the execution status of the construction tasks in the matrix unit (for example, update from “in progress 90%” to “completed”, or for example, update from “in progress 10%” to “in progress 20%”); and matching and updating the corresponding color coding for the matrix unit with the re-determined status information based on the preset color coding, so as to reflect a latest progress of the construction project in real time in the visualization view. The percentage of the “in-progress” stage may be determined based on a ratio of completed construction tasks included in the matrix unit and a total count of construction tasks.

In 1070, a visualization view displaying visual progress is generated.

In some embodiments, the visualization view includes a view presented in a two-dimensional table format. In the view presented in the two-dimensional table format, a vertical axis displays a plurality of construction areas, and a horizontal axis displays a plurality of progress nodes.

The visual progress refers to a management approach that presents the progress status of the construction project in an intuitive and graphical manner. In some embodiments, the visual progress may organically combine the progress in a time dimension (represented by the progress nodes) with the positions in a spatial dimension (represented by the construction areas) through a two-dimensional matrix structure, thereby enabling the management personnel to quickly grasp the overall project status like viewing a “visual map”.

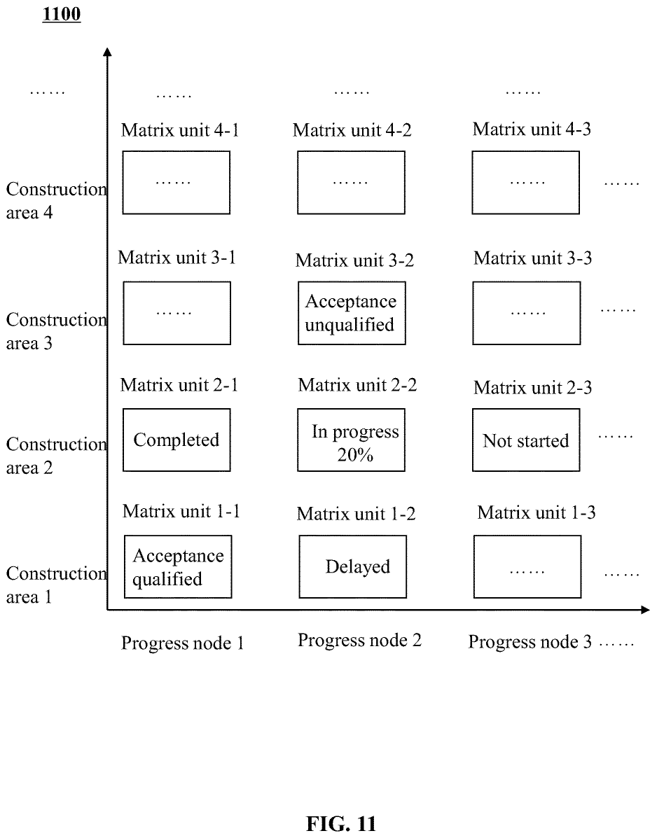

The visualization view refers to a user interface configured to carry and display the visual progress. For example, the visualization view may be a view presented in a two-dimensional table format as shown in FIG. 11. As another example, the visualization view may refer to a visualized 3D view. In some embodiments, the visualized 3D view may be a digital 3D scene that is formed by mapping and rendering the status information of the plurality of matrix units onto the virtual building model through preset graphic attributes (such as a color, a transparency, or the like), and is available for interactive browsing by the user.

In the visualized 3D view, the displayed color of each component or space (such as a wall or a room) on the virtual building model may dynamically reflect the progress status of the related construction tasks within its corresponding construction area. For example, a floor slab that is undergoing main structure construction may be rendered as yellow, while a wall that has completed plastering is rendered as green. By performing interactive operations such as rotation, zooming, and panning on the 3D view, the user may intuitively and immersively perceive the actual construction progress of the entire project from any angle.

FIG. 11 is a schematic diagram illustrating an exemplary visualization view according to some embodiments of the present disclosure.

As shown in FIG. 11, a visualization view chart 1100 presented in a two-dimensional table format is illustrated. In the visualization view chart 1100, a vertical axis displays a plurality of construction areas in a list format, for example, “Construction area 1”, “Construction area 2”, “Construction area 3”, “Construction area 4”, or the like, thereby dividing the project according to spatial distribution in a vertical direction. A horizontal axis corresponds to a plurality of progress nodes, for example, “Progress node 1”, “Progress node 2’, “Progress node 3”, or the like, thereby dividing the project according to construction process stages in a horizontal direction. Each cell formed by the intersection of the vertical axis and the horizontal axis is a matrix unit. For example, “Matrix unit 2-3” is formed by the intersection of “Construction area 2” and “Progress node 3”.

As shown in FIG. 11, each cell (matrix unit) may display an execution status of assigned construction tasks in the corresponding construction area. For example, the “in progress 20%” displayed in the cell of “Matrix unit 2-2” indicates that the completion progress of the currently in-progress construction task is 20%. Furthermore, since the construction tasks in each matrix unit inherently have a construction sequence, based on the displayed content of “Matrix unit 2-2”, the user may also know that the construction tasks preceding the current construction task have been completed. As another example, the “completed” displayed in “Matrix unit 2-1” and the “delayed” of “Matrix unit 1-2” respectively indicate that the construction tasks of corresponding matrix units have been completed or are delayed.

In some embodiments, the visualization view chart 1100 may further indicate the acceptance status of the construction tasks in the construction area corresponding to the matrix unit. For example, “Matrix unit 1-1” is displayed as “acceptance qualified”, indicating that all construction tasks within it are not only completed, but also passed the quality acceptance. As another example, “Matrix unit 3-2” is displayed as “acceptance unqualified”, indicating that a completed construction task within the matrix unit failed to pass the quality acceptance and requires rectification.

In some embodiments, the processor may fill different cells with different colors based on the color coding rules (not shown in FIG. 11). Although not shown in color in FIG. 11, in some embodiments, “Matrix unit 1-1” may be filled with white to indicate that all tasks within the matrix unit are completed and have passed quality acceptance; “Matrix unit 1-2” may be filled with red to indicate that the construction tasks in the matrix unit are delayed; “Matrix unit 2-1” may be filled with green to indicate that all construction tasks in the matrix unit are “completed”; “Matrix unit 2-2” may be filled with yellow to indicate that the construction tasks in the matrix unit are “in progress”; “Matrix unit 2-3” may be filled with gray to indicate that the construction tasks in the matrix unit are “not started”; and “Matrix unit 3-2” may be filled with orange to indicate that the construction tasks in the matrix unit are completed but have not passed quality acceptance. In this manner, the visualization view chart 1100 may intuitively present the progress status of the entire project to the management personnel.

In some embodiments, the processor may map each matrix unit to a cell in the table, wherein a row position of the cell is determined by the construction area corresponding to the cell, and a column position thereof is determined by the progress node corresponding to the cell, and then generate the visualization view. The processor performs background color filling on the cell based on the color coding corresponding to the latest status information of each matrix unit. Thus, the management personnel may quickly identify the completion status of different construction areas by observing the colors of different cells in the table (for example, green indicates “completed”, and yellow indicates “in progress”), thereby achieving intuitive and macroscopic monitoring and problem identification of the project progress.

In some embodiments, generating the visualization view displaying the visual progress includes: obtaining a plurality of pieces of position information of the plurality of construction areas and a plurality of pieces of status information of the plurality of matrix units; and mapping the plurality of pieces of status information to spatial positions in a virtual building model based on the plurality of pieces of position information to form a visualized 3D view.

The position information refers to coordinate data used to position a construction area in a three-dimensional space. For example, the position information of a construction area (such as Room A) may include a three-dimensional bounding box of the construction area and of each building component (such as walls, slabs, columns, etc.) within the construction area, in a three-dimensional space of a physical building. In some embodiments, the position information may be directly extracted from a building information model or three-dimensional CAD drawings of the construction project.

The virtual building model refers to a digital three-dimensional model corresponding to the physical building in terms of geometric shape and spatial position, for example, the building information model. In the virtual building model, each virtual building component of the virtual building (such as virtual walls, virtual slabs, virtual columns, etc.) is an independent object and carries the corresponding position information.

In some embodiments, the processor may traverse each matrix unit, obtain the status information thereof, and convert the status information into preset graphical attributes according to a preset mapping rule. In some embodiments, the preset mapping rule may include a status mapping rule. For example, the status mapping rule may include progress statuses such as “Not Started”, “In Progress”, “Completed”, and “Delayed”, etc., which are respectively mapped to different colors such as gray, yellow, green, and red, etc.

In some embodiments, the processor traverses each matrix unit to be displayed and performs mapping. The mapping includes obtaining the status information of the matrix unit and the position information of the corresponding construction area of the matrix unit, based on the position information, querying and positioning one or more three-dimensional virtual building components or virtual spaces that spatially correspond thereto in the virtual building model, based on the aforementioned mapping rule, converting the status information of the matrix unit into a specific set of graphical attributes and applying the set of graphical attributes to the newly positioned three-dimensional virtual building components or virtual spaces, and after the status information of all matrix units is converted, performing three-dimensional rendering to finally form the visualized 3D view.

In some embodiments, when performing the mapping, the processor may further add the execution status of the construction tasks in each matrix unit in text form to the three-dimensional virtual building components or virtual spaces corresponding to the matrix unit. For example, text “Construction task A: 50% Completed” may be attached to a three-dimensional virtual building component corresponding to a certain matrix unit.

In some embodiments, the mapping rule may further include a quality mapping rule. For example, the quality mapping rule may include quality ratings such as “Excellent”, “Good”, and “Qualified”, etc., which are mapped to different color saturations such as high, medium, and low, etc. In some embodiments, if the matrix unit is completed, the processor may further adjust the color saturation thereof based on the final quality rating and the quality mapping rule. For example, for a quality rating of “Excellent”, high-saturation green is used; for a quality rating of “Qualified”, low-saturation green is used, to visually reflect quality differences.

In some embodiments, the mapping rule further includes an anomaly mapping rule. For example, the anomaly mapping rule may include mapping anomaly statuses such as duration delay or cost overrun to special display effects such as high-brightness flashing or semi-transparency. In some embodiments, if the anomaly detection of the matrix unit fails, for example, due to duration delay or cost overrun, the processor may attach the special display effect thereto, such as high-brightness flashing or semi-transparent processing, etc., to highlight warnings in the visualized 3D view.

In some embodiments, the processor obtains the position information of the construction area corresponding to the matrix unit and utilizes the position information to retrieve and position the three-dimensional virtual building component or virtual space corresponding to the matrix unit in the virtual building model. The processor applies the aforementioned graphical attributes to the positioned three-dimensional virtual building component and renders the entire virtual building model, thereby generating a user-interactive (e.g., rotation, zooming, panning, roaming) visualized 3D view.

In some embodiments, the virtual building model may further respond to a click operation of a user. For example, when the user clicks on a rendered virtual building component in the virtual building model (such as a wall rendered in yellow), the processor may query and display detailed information of the matrix unit associated with the building component. The detailed information may include a current construction task name (such as “Masonry Infill”), a performance entity (such as “Team XX”), a planned completion time, and a current progress percentage.

For more details about quality rating and anomaly detection, please refer to FIG. 13 and related descriptions thereof.

In some embodiments of the present disclosure, by presenting “visual progress” in a two-dimensional table format with color coding, the intuitiveness of progress monitoring and decision-making speed are significantly improved. The management personnel may quickly identify the current construction status of the construction area (e.g., whether there is a construction task delay) and thus quickly locate problems. By constructing structured “matrix units”, a clear data query framework is provided. Management personnel may conveniently query the completion status of all construction tasks in various construction areas or query the completion status of a certain construction task in all areas. Furthermore, the approach precisely locates construction tasks to specific spatial areas, laying a foundation for refined management that better aligns with actual on-site conditions. This enables the system to arrange a more optimal construction sequence in subsequent decisions by combining factors such as spatial relationship, resource allocation distance, etc. Thereby, problems of unintuitive progress monitoring and inefficient task assignment in traditional management may be effectively solved.

In some embodiments of the present disclosure, by constructing a view presented in a two-dimensional table format with the construction areas and the progress nodes as axes and by utilizing color coding, an intuitiveness and efficiency of progress monitoring are greatly enhanced, which may visually display the construction progress, thereby improving the assignment efficiency of construction tasks and enabling management personnel to quickly locate progress deviations. By determining the first task to be assigned through the difference set and by using the weight coefficient of the matrix unit, the priority of the first task to be assigned is determined, thereby achieving automation and intelligence of task assignment and reducing the complexity and error rate of manual management. By binding the progress nodes (a plurality of construction tasks with construction sequence) and the construction areas and forming structured matrix units, a solid data foundation is provided for refined management and data-driven decision-making of construction projects.

FIG. 12 is a flowchart illustrating an exemplary process for determining a priority of a first task to be assigned according to some embodiments of the present disclosure.

As shown in FIG. 12, a process 1200 includes the following operations 1210-1230. In some embodiments, the process 1200 may be performed by a processor.

In 1210, a first weight coefficient of each matrix unit is determined based on a basic logic among a plurality of progress nodes.

The basic logic refers to a construction logical relationship determined by construction techniques, technical standards, and safety management requirements. In some embodiments, the basic logic includes an inherent and unchangeable predecessor-successor relationship and a logical sequence among different progress nodes. For example, the basic logic includes that a “Main Structure” progress node may only begin after a “Foundation and Substructure” progress node is completed.

The processor may obtain the basic logic in a plurality of manners. In some embodiments, the processor may obtain the basic logic from preset dependency data contained in a progress node template library. The preset dependency data may be preset in advance by professionals in the art based on construction techniques, technical standards, and safety management requirements.

For more details about the progress node template library, please refer to FIG. 10 and related descriptions thereof.

In some embodiments, the preset dependency data may be stored in the form of a rule list or a data table in the progress node template library. For example, the rule list or the data table includes Rule 1, Rule 2, etc. Rule 1: defines a predecessor condition for “Main Structure Engineering” (Progress node PN-02). Rule 1 stipulates that the start of “Main Structure Engineering” must be predicated on the complete fulfillment of “Foundation and Substructure Engineering” (Progress node PN-01). This is a type of Finish-to-Start dependency. Rule 2: defines a predecessor condition for “Roofing and Waterproofing Engineering” (Progress node PN-03). Rule 2 stipulates that the start of “Roofing and Waterproofing Engineering” must be predicated on the complete fulfillment of “Main Structure Engineering” (Progress node PN-02).

The first weight coefficient refers to a static weight value that reflects the importance of the matrix unit. In some embodiments, the value of the first weight coefficient depends on the position of the progress node corresponding to the matrix unit in the basic logic of the entire project. In some embodiments, the processor may identify the progress nodes located on the critical path of the project through critical path analysis, and assign a higher first weight coefficient to all matrix units corresponding to these progress nodes. In some embodiments, the processor may also assign a higher first weight coefficient to matrix units corresponding to key hub nodes with a large number of successor dependent tasks. Conversely, for nodes not on the critical path and with fewer dependencies, a lower first weight coefficient is assigned.

The critical path analysis refers to determining whether a progress node is located on the critical path. For more details about how to determine whether a progress node is located on the critical path, please refer to FIG. 10 and related descriptions thereof.

In some embodiments, the processor may determine a count of successor dependent tasks for each progress node that serves as a predecessor node. When the processor detects that the count of successor dependent tasks of a certain progress node exceeds a quantity threshold, the processor determines the certain progress node as a “key hub node with a large number of successor dependent tasks”. For example, when parsing the basic logic, the processor may identify that the completion of the progress node “Main Structure Engineering” is a common prerequisite for the start of a plurality of successor progress nodes, such as “Masonry Infill Wall Engineering”, “Exterior Wall Door and Window Installation Engineering”, and “Indoor Electromechanical Pipeline Laying Engineering”. That is, the construction tasks corresponding to the plurality of successor progress nodes, such as “Masonry Infill Wall Engineering”, “Exterior Wall Door and Window Installation Engineering”, and “Indoor Electromechanical Pipeline Laying Engineering”, are successor dependent tasks of the progress node “Main Structure Engineering”. If the count of the successor dependent tasks of the progress node “Main Structure Engineering” reaches the quantity threshold (for example, greater than or equal to 5), the processor determines the “Main Structure Engineering” as a key hub node. In response to the determination result, the processor also assigns a higher first weight coefficient to all matrix units corresponding to the progress node “Main Structure Engineering”, to ensure the priority completion of the bottleneck node, thereby creating conditions for the parallel execution of a plurality of subsequent construction tasks.

In 1220, a second weight coefficient of each matrix unit is determined based on a progress pressure of each matrix unit.

The progress pressure refers to a quantitative manifestation of the time urgency and resource constraint faced by completing a specific progress node in a specific construction area. In some embodiments, the progress pressure is dynamically variable, and reflects a deviation between an actual execution status and a plan during the execution process of the construction project. In some embodiments, the progress pressure may be obtained by comparing a planned completion time of the matrix unit with a current elapsed time, and a difference between a planned workload and an actual completed workload within the current elapsed time. For example, the smaller the value of [the planned completion time−the current elapsed time] and the smaller the ratio of the actual completed workload to the planned workload, the greater the progress pressure.

In some embodiments, the processor may obtain the progress pressure by querying a first preset table based on the value of [planned completion time−current elapsed time] (an actual deviation) and the ratio of the actual completed workload to the planned workload (a workload deviation). The first preset table may be a two-dimensional lookup table, which defines progress pressure levels corresponding to combinations of different degrees of time deviations and workload deviations. In some embodiments, the first preset table may be constructed by experts with rich project management experience to define pressure scores under different deviation combinations according to industry practices and management requirements.

In some embodiments, the processor may also perform normalization processing on the obtained progress pressure to convert the progress pressure into a standardized progress pressure between 0 and 1. The processor may adopt a linear function normalization (Min−Max Scaling) approach, a z-score normalization approach, and other approaches.

The second weight coefficient is a weight value used to reflect the dynamic urgency of a matrix unit. For example, a matrix unit that has been delayed, or a matrix unit whose remaining duration is very tight, may be assigned a higher second weight coefficient to prompt prioritization of the tasks of the matrix unit.

In some embodiments, the processor may determine the second weight coefficient of each matrix unit based on the progress pressure of each matrix unit by utilizing a positive correlation relationship between the progress pressure of each matrix unit and the second weight coefficient of each matrix unit. For example, the processor may directly use the normalized progress pressure as the second weight coefficient.

In some embodiments, the processor may also determine the second weight coefficient based on a readiness status of resources required by the matrix unit. For example, the processor determines whether key resources, such as personnel, equipment, or materials, required for executing the matrix unit are in place and in a standby status by querying a resource management database. To avoid resource idleness and improve utilization efficiency, in response to detecting that the key resources are ready, the processor may accordingly increase the second weight coefficient of the matrix unit to prompt the matrix unit to be prioritized for assignment.

The resource management database refers to a database used for centrally recording and real-time tracking the status of all production factors (including personnel, equipment, and materials) required by the construction project. For example, the resource management database may include a list of all construction teams and their members, skill qualifications of each member, currently assigned tasks, and future available work schedules. As another example, the resource management database may include a list of all large machinery and equipment, model specifications, real-time position obtained via GPS or RFID, current working status (for example, “in operation”, “idle standby”, or “under maintenance”), and future scheduled usage plans. As yet another example, the resource management database may include inventory quantity of various key construction materials, storage warehouse positions, and status of purchase orders (for example, “placed”, “in transit”, or “received and warehoused”). In some embodiments, information in the resource management database may be manually entered by management personnel, or automatically synchronized and updated through data interfaces with IoT devices, procurement management systems, and other information systems.

In some embodiments, the processor may determine the second weight coefficient based on the progress pressure of the construction area corresponding to each matrix unit and second progress pressure of the progress node corresponding to each matrix unit.

The first progress pressure refers to a comprehensive progress urgency faced by a specific construction area. In some embodiments, the first progress pressure is associated with a deviation degree between an execution status and a plan of all progress nodes within the construction area. In some embodiments, the processor may determine a ratio of a count of progress nodes in a “delayed” status within a construction area to a total count of progress nodes within the construction area, and the higher the ratio, the greater the first progress pressure. Alternatively, by comparing a planned completion rate and an actual completion rate of all progress nodes within a construction area, the greater the difference, the greater the first progress pressure.

The planned completion rate of all progress nodes within the construction area refers to a proportion of a count of progress nodes that should have been completed according to a project plan within a specific construction area at a current point in time, to a total count of progress nodes planned to be executed in the construction area. The actual completion rate of all progress nodes within the construction area refers to a proportion of a count of progress nodes that have actually been completed (for example, with a status of “acceptance qualified”) within the construction area at the current point in time, to a total count of progress nodes planned to be executed in the construction area. For example, for a construction area identified as “Building 1, Floor 3”, a total of 10 progress nodes are planned to be executed within the construction area. As of a current date, the project plan requires that 6 progress nodes should have been completed, then the planned completion rate of the construction area is (6/10)=60%. If, at this time, only 4 progress nodes have actually been completed, then the actual completion rate of the construction area is (4/10)=40%. The processor compares the significant difference between the two (60% compared to 40%), and determines that the first progress pressure of the construction area is high.

The second progress pressure refers to a comprehensive progress urgency faced by a specific progress node. In some embodiments, the second progress pressure is associated with a deviation degree between an execution status and a plan of the progress node in all construction areas. In some embodiments, the processor determines a deviation between a planned completion rate and an actual completion rate of the progress node corresponding to the matrix units in all construction areas, and the greater the deviation, the greater the second progress pressure. Alternatively, the processor determines whether the progress node is currently on the critical path of the construction project, and if so, the corresponding second progress pressure is accordingly increased.

The planned completion rate of the progress node corresponding to the matrix units in all construction areas refers to a proportion of a count of construction areas that should have been completed according to the project plan among all applicable construction areas for a specific progress node at the current point in time, to a total count of applicable construction areas. The actual completion rate of the progress node corresponding to the matrix units in all construction areas refers to a proportion of a count of construction areas that have actually been completed among all applicable construction areas for a specific progress node at the current point in time, to the total count of applicable construction areas. For example, the progress node is “interior plastering”, and the progress node is planned to be implemented in 20 construction areas (e.g., 20 indoor units). As of the current date, the project plan requires that the progress node should be completed in 15 construction areas, then the planned completion rate of the progress node is (15/20)=75%. If at this time, a site reports that the progress node is actually completed in only 10 construction areas, then the actual completion rate of the progress node is (10/20)=50%. The processor determines, based on a relatively large difference between the two (75% compared to 50%), that the progress node “interior plastering” faces relatively high second progress pressure.

In some embodiments, the processor may determine the second weight coefficient based on the first progress pressure and the second progress pressure, in accordance with the positive correlation relationship between the second weight coefficient and the first progress pressure and the second progress pressure. For example, the processor may perform normalization processing based on the first progress pressure of the construction area corresponding to the matrix unit and the second progress pressure of the progress node corresponding to the matrix unit (as described above for normalizing the progress pressure), and perform a weighted summation on the two after normalization, to obtain the second weight coefficient.

In some embodiments of the present disclosure, by further decomposing the progress pressure into the first progress pressure based on the construction area and the second progress pressure based on the progress node, the processor no longer merely obtains a general “delay” conclusion, but may distinguish specific dimensions of the problem. If the first progress pressure of a certain construction area is generally high, it may mean that the construction area has regional and physical bottlenecks, such as inconvenient traffic or untimely material supply. Conversely, if the second progress pressure of a certain progress node is generally high, it may mean that the team responsible for the process has process-related and management-related problems, such as insufficient skills or personnel shortage. Such fine-grained pressure analysis enables management personnel to make more targeted decisions, thereby precisely allocating limited resources (e.g., management effort, additional personnel, etc.) to the most critical bottlenecks, achieving more efficient and fundamental dynamic adjustments, and thus effectively ensuring the overall project progress.

In 1230, a priority of the first task to be assigned is determined based on a comprehensive result of the first weight coefficient and the second weight coefficient.

The comprehensive result refers to a result of comprehensively determining the first weight coefficient and the second weight coefficient.

In some embodiments, the process for obtaining the comprehensive result may be performing a weighted determination on the first weight coefficient and the second weight coefficient. For example, the processor may determine: the comprehensive priority score of the matrix unit=(the first weight coefficient×weight γ)+(the second weight coefficient×weight δ), where, γ and δ are preset reconciliation parameters used for balancing the proportion of “inherent basic logic importance” (represented by the first weight coefficient) and “dynamic on-site urgency” (represented by the second weight coefficient) in the final decision.

In some embodiments, γ and δ may be preset by manual experience or historical experience.

In some embodiments, the processor may, for each matrix unit that includes the first task to be assigned, determine its comprehensive priority score based on the aforementioned manner; and sort all these matrix units in descending order based on the comprehensive priority score. It may be understood that this sorting result determines the task assignment priority order among the different matrix units. For a matrix unit having a higher comprehensive priority score, the first task to be assigned within the matrix unit may obtain a higher priority, and for a plurality of first tasks to be assigned included within the same matrix unit, the execution order of the plurality of first tasks to be assigned follows the aforementioned inherent construction order predefined in the progress node. For more details about the construction order, please refer to FIG. 10 and related descriptions thereof.

In some embodiments of the present disclosure, by combining a static first weight coefficient with the dynamic second weight coefficient to determine the priority of the first task to be assigned, task assignment decisions may not only closely revolve around the macroscopic strategic objectives of the project (ensuring the priority of the critical paths and the critical hubs through the first weight coefficient) but also flexibly respond to microscopic changes and unexpected situations at the construction site (resolving the current progress bottlenecks through the second weight coefficient). This static-dynamic combined decision-making mechanism ensures that project resources are always directed to where they are most needed, effectively reduces resource idleness and an invalid waiting time caused by poor process coordination, thereby, while ensuring a project quality, achieves objectives of reducing construction costs and shortening a total duration, and maximizes an overall project execution efficiency.

FIG. 13 is a schematic diagram illustrating an exemplary process for generating a construction task sheet corresponding to each matrix unit according to some embodiments of the present disclosure.

In some embodiments, as shown in FIG. 13, the processor may, based on a selected construction task 1310, extract standardized content 1330 from a knowledge base 1320, and generate a construction task sheet 1340 corresponding to each matrix unit. The construction task sheet 1340 includes a construction area 1341, a construction task procedure 1342, a work disclosure 1343, a safety disclosure 1344, and an acceptance criterion 1345 corresponding to each matrix unit. The construction task sheet 1340 is the second project document in process 400.

For more details about the matrix unit, the construction area, etc., please refer to FIG. 10 and related descriptions thereof.

The knowledge base 1320 refers to a structured database used for storing standardized construction management and technical knowledge. In the knowledge base 1320, content is organized and stored with a single construction task as an index. For example, for different construction tasks such as “concrete pouring” and “wall plastering”, a complete set of corresponding technical specifications, management requirements, and historical data, etc., are pre-stored. In some embodiments, the knowledge base 1320 further stores a standard work disclosure, a standard safety disclosure, standard acceptance criteria, and historical performance data. The standard work disclosure describes in detail text, images, or video materials related to construction task operation processes, technical points, and quality requirements. The standard safety disclosure clearly indicates text materials related to safety risks existing in the construction tasks, safety regulations that must be followed, and emergency handling measures. The standard acceptance criteria specify the specific specification clauses, allowable deviation values, and standardized inspection forms serving as a basis for quality inspection after the construction task is completed. The historical performance data includes historical data accumulated from past projects regarding the average duration, construction volume, completed resource consumption, typical resource consumption models, etc., of this type of task. Therefore, when the processor needs to generate a construction task sheet for “wall plastering”, the processor may directly and precisely extract standard work disclosure, safety disclosure, and acceptance criterion specifically for “wall plastering” from the knowledge base 1320.

In some embodiments, the knowledge base 1320 may be constructed based on manual experience or historical experience. In some embodiments, the knowledge base 1320 may also be constructed based on industry standard processes for building construction, etc.

The standardized content 1330 refers to predefined information extracted from the knowledge base 1320 and used for populating the construction task sheet 1340. The standardized content may be understood as a general document directory in FIG. 4. In some embodiments, the standardized content 1330 aims to ensure that construction tasks assigned to different teams and used for different construction areas but belonging to the same type have consistent technical, safety, and quality requirements. In some embodiments, the standardized content 1330 may include the standard work disclosure, the standard safety disclosure, and the standard acceptance criteria.

In some embodiments, the selected construction task is a type of construction task, corresponding to a unique identifier (e.g., a unique name or a unique code, etc.). According to the unique identifier (e.g., a unique name or a unique code, etc.) of the selected construction task 1310, the processor may query, retrieve, and extract the standardized content 1330 of the selected construction task from the knowledge base 1320.

The construction task sheet 1340 refers to a work instruction issued to a performance entity (e.g., a construction team) that specifically executes a construction task, and includes all information required to execute the construction task. The construction task sheet 1340 is a basis document for guiding on-site construction, clarifying responsibilities, and ensuring safety and quality. For example, a construction task sheet may be executing a “wall plastering” task for “Building 1, Unit 301”, and the content of the construction task sheet may specify in detail the work instructions, safety precautions, and quality acceptance criteria, etc., for the construction task.

The construction task procedure 342 refers to the name of the construction task explicitly recorded in the construction task sheet 1340 and its position in the predefined construction order. For more details about the construction order, please refer to FIG. 10 and related descriptions thereof. In some embodiments, when generating a construction task sheet for a certain matrix unit, the processor may directly obtain a list of selected construction tasks arranged according to the predefined construction order within the matrix unit, to generate the construction task procedure 1342.

The work disclosure 1343 refers to technical specifications, operation processes, construction key points, quality requirements, etc., indicated to operators for the construction task procedure to ensure construction quality. For example, for a “concrete pouring” construction task, the work disclosure may include pouring order, vibrating manner, curing requirements, etc. In some embodiments, the work disclosure 1343 may include text, images, or videos.

The safety disclosure 1344 refers to safety protection measures, safe operating procedures, risk warnings, emergency handling methods, etc., that must be indicated to operators for safety risks existing in the specific construction task procedure.

The acceptance criterion 1345 refers to a standard based on which a quality inspection is performed after a construction task is completed. In some embodiments, the acceptance criterion 1345 may include specific specifications, allowable deviation values, inspection methods, clauses, specification numbers, inspection forms, etc.

In some embodiments, the processor may create a blank template of the construction task sheet 1340 for the selected construction task 1310. The processor populates the template with the determined information corresponding to the selected construction task 1310, such as the construction area 341 and the construction task procedure 1342. The processor may use the unique identifier of the selected construction task 1310 as an index to query and extract the matching standardized content 1330 from the knowledge base 1320. The extracted standardized content 1330 may include the work disclosure 1343, the safety disclosure 1344, and the acceptance criterion 1345 corresponding to the construction task. The processor may fill the extracted standardized content 1330 into the corresponding fields or positions of the template of the construction task sheet 1340, thereby generating the construction task sheet 1340.

In some embodiments of the present disclosure, by extracting the standardized content from the knowledge base and generating the construction task sheet corresponding to each matrix unit based on the selected construction task, the efficiency of task assignment is greatly improved, the manual workload of managers is reduced, and the probability of errors caused by manual entry is decreased. Meanwhile, by using the standardized work, safety, and acceptance content, the uniformity and consistency of project management requirements are ensured, and a solid foundation is provided for ensuring construction quality and safe production.

In some embodiments, as shown in FIG. 13, the construction task sheet 340 further includes a first planned duration 1346, a resource requirement 1347, and a performance entity 1348. The processor may predict the first planned duration 1346 and the resource requirement 1347 based on historical construction data 1350 by a prediction algorithm; and determine the performance entity 1348 based on the first planned duration 1346 and the resource requirement 1347 by a capability database 1360.

The historical construction data 1350 refers to actual construction data recorded in the completed construction tasks of past construction projects or current construction projects. In some embodiments, each piece of historical construction data corresponds to a completed construction task and includes information such as an actual completion duration, actual completed resource consumption, a final performance entity, and work environment parameters during the execution of the completed construction task. The actual completion duration refers to a working time spent on completing the construction task. The actual completed resource consumption refers to quantitative data of various production factors actually consumed for completing the construction task. For example, the actual completed resource consumption may include actual labor consumption (e.g., recorded as “20 man-hours for senior technicians, 35 man-hours for general workers”), actual material consumption (e.g., “5 tons of XX type cement”), and actual machinery shift consumption (e.g., “8 shifts for tower cranes”).

In some embodiments, the processor may obtain the historical construction data 1350 by performing statistics on the archived construction task sheets and the acceptance records in the storage device of the system 300.

The prediction algorithm refers to an algorithm used for learning and analyzing based on the historical construction data 1350 to estimate a planned duration and a resource requirement of a future task to be assigned.

The first planned duration 346 refers to an estimated working time required to complete a single selected construction task. For example, the first planned duration of the construction task may be “3 working days” or “24 standard man-hours”.

The resource requirement 1347 refers to various production factors consumed to complete a single selected construction task. In some embodiments, the resource requirement 1347 may include professional qualification requirements for construction teams, work crews, or subcontractors, labor requirements (e.g., requiring “2 senior electricians, 3 general workers”), material requirements (e.g., “500 meters of a certain specification of cable”), and machinery and equipment requirements (e.g., “a 16-ton truck crane working for 8 hours”), or the like.

In some embodiments, the processor may, based on the historical construction data, execute a prediction algorithm to obtain the first planned duration 1346 and the resource requirement 1347. In some embodiments, the prediction algorithm may be a weighted average manner, one or more machine learning models, or the like. For example, the processor may pre-train a regression model (such as a linear regression, decision tree regression, or gradient boosting machine model) using a large amount of historical construction data, historical planned durations, and historical resource requirements. In the prediction stage, the processor inputs the historical construction data of the selected construction task 1310 (a plurality of pieces of attribute data, such as construction task type, project quantity, construction area, etc.) as features into the trained model. The model then outputs prediction values for the first planned duration 1346 and the resource requirement 1347. In some embodiments, the processor may positon the progress node corresponding to the selected construction task 310 to read the construction area corresponding to the progress node; determine the construction task type based on the task name of the selected construction task; and retrieve the corresponding construction quantity from the knowledge base 1320.

In some embodiments, a preset algorithm (e.g., a weighted average manner or a machine learning regression model) further includes determining and outputting prediction data for the first planned duration 1346 and the resource requirement 1347 corresponding to the selected construction task based on the actual completion duration and the actual completed resource consumption of the aforementioned similar task records.

The capability database 1360 refers to a database storing detailed capability and performance profiles of all available performance entities. In some embodiments, contents stored in the capability database 1360 include at least one of professional qualifications, skill levels, historical capacity levels, current workload status, and historical performance data (such as duration compliance rate, quality pass rate, safety records, etc.) of each construction team, work crew, or subcontractor. In some embodiments, the related data in the capability database 1360 may be manually entered and reviewed by project managers via a user terminal.

The performance entity 1348 refers to a responsible entity specifically in charge of executing the selected construction task. For example, a performance entity may be a construction team, a work crew, or a subcontractor.

In some embodiments, the processor uses the first planned duration 346 and the resource requirement 1347 as the matching conditions to query and filter out candidate performance entities in the capability database 1360 that simultaneously satisfy the following conditions: having the professional qualifications required to execute the selected construction task, and currently having sufficient available manpower and time to meet the first planned duration and the resource requirement. For example, the processor compares the first planned duration 1346 with the available capacity of a candidate performance entity in the capability database 1360 to determine whether the candidate performance entity has the capability to complete the task within the given planned duration. Specifically, if a planned duration of a task is 3 days, a total workload required is 15 man-days, and the available capacity of a team is determined to be 6 man-days per day, then the team may provide a capacity of 18 man-days within 3 days (6*3=18), which is greater than the required 15 man-days, and thus it is determined that the matching is successful. Conversely, if the available capacity is insufficient, the team is removed from the candidate list.

In some embodiments, if there are a plurality of candidate performance entities, the processor may also rank them based on the historical performance of the plurality of candidate performance entities, to determine and select the optimal performance entity 1348 (e.g., the candidate performance entity with the highest historical performance).

In some embodiments of the present disclosure, by introducing prediction based on the historical construction data and a matching mechanism based on the capability database, the accuracy and scientific rigor of selected construction task assignment may be significantly improved. Data-driven prediction replaces traditional manual estimation, reducing the risks of duration delays and resource waste caused by insufficient experience. Secondly, intelligent matching between selected construction tasks and performance entities is achieved, ensuring that appropriate selected construction tasks are assigned to teams with the most suitable capabilities, optimal performance, and available schedules, thereby fundamentally ensuring construction quality and efficiency, and optimizing the overall human resource allocation of the project.

In some embodiments, the processor may determine the construction task sheet of the first task to be assigned in the aforementioned similar manner.

In some embodiments, as shown in FIG. 13, the processor may, based on the construction task sheet 1340, perform an anomaly detection on the execution status, the anomaly detection including a duration detection and a resource consumption detection; and in response to the anomaly detection failing, issue a warning for each progress node.

For more details about the execution status, please refer to FIG. 11 and related descriptions thereof.

The anomaly detection refers to a process of continuously comparing actual execution data with preset planned data in the construction task sheet 1340 during the actual execution of a construction task, to identify whether a significant deviation exists. In some embodiments, the actual execution data may include an actual elapsed duration and an actual consumed resource quantity. In some embodiments, the preset planned data corresponds to the first planned duration 346 and the resource requirement 1347 in the construction task sheet 1340.

In some embodiments, when the deviation between the actual execution data and the preset planned data in the construction task sheet 1340 is greater than a deviation threshold, it is determined that the anomaly detection of the execution status of the construction task fails. The deviation threshold refers to one or more preset critical values used to define normal fluctuations and abnormal deviations. In some embodiments, the deviation threshold may include an actual overdue threshold and a resource overdue threshold, and the deviation threshold may be determined based on human experience or historical experience.

The duration detection refers to a detection process of comparing the actual elapsed duration of a construction task with the first planned duration 1346 of the construction task. In some embodiments, the processor may obtain an actual start time of the construction task, and continuously monitor the current time to obtain the actual elapsed duration, and compare the actual elapsed duration with the first planned duration 1346 in the construction task sheet 1340. When the actual elapsed duration exceeds the first planned duration (or a portion thereof pro-rated by progress) and the deviation reaches a preset time overdue threshold, it is determined that the duration detection fails. The portion thereof pro-rated by progress means that the processor compares the actual elapsed duration with the planned duration pro-rated by progress. For example, if the current actual elapsed duration is 5 days, the progress of completed construction task X is 50%, but the first planned duration is 6 days, meaning only 3 days (planned required duration) are needed in the first planned duration to complete 50% progress of the construction task X. At this time, the processor compares this “actual elapsed duration” (5 days) with the determined “planned required duration” (3 days). When the “actual elapsed duration” exceeds the “planned required duration”, and the deviation (5−3=2 days) reaches the preset time overdue threshold, it is determined that the duration detection fails, and a warning is triggered.

The resource consumption detection refers to a detection process of comparing the actual consumed resource quantity of a construction task with its resource requirement 1347. In some embodiments, the processor may obtain from the data collection terminal at the construction site the actual quantity of labor (e.g., man-hours), materials (e.g., usage), or machinery (e.g., shifts) consumed by the construction task, and cumulatively compare this actual quantity with the planned resource consumption set for various types of resources in the construction task sheet 1340. When the actual consumption of any type of resource exceeds its planned requirement and the deviation reaches a preset resource overspending threshold, it is determined that the resource consumption detection fails. The planned resource consumption set for various types of resources may be manually configured, or may use the average of the completed resource consumption of various types of resources used to complete such construction tasks historically (which may be obtained from the knowledge base 1320).

In some embodiments, in response to the anomaly detection failing, the processor performs a warning operation. In some embodiments, the warning operation may include: positioning the matrix unit corresponding to the construction task whose anomaly detection failed, and the progress node corresponding to the matrix unit; and sending an alert signal to the manager managing the construction task. The alert signal may take a plurality of forms. For example, in the visualization view, the corresponding matrix unit is specially marked (e.g., changed from yellow to red, or adding a highlighting flicker effect), or a notification message containing anomaly details is directly pushed to the user terminal of a project manager.

In some embodiments of the present disclosure, duration warning enables the timely detection and intervention of delayed tasks. An alert is automatically sent to managers at the first instance when a construction task experiences a substantial delay and exceeds a management tolerance (i.e., a deviation threshold), which avoids problems caused by delayed information due to multi-level transmission. This ensures that managers may quickly intervene, analyze delay causes, and take remedial measures, thereby preventing the delayed construction tasks from causing ripple effects on successor progress nodes and even the total duration of the entire project. Additionally, through resource consumption warning, dynamic monitoring and adjustment of cost overruns are achieved, and a warning is immediately issued once consumption exceeds a preset threshold. This helps to timely detect problems such as material waste, low labor efficiency, or inaccurate original plan estimation, enabling managers to immediately initiate investigations and make dynamic adjustments.

In some embodiments, in response to the selected construction task 1310 being completed, the processor may perform a quality rating on the selected construction task 1310 based on the acceptance criterion 1345; and in response to the quality rating satisfying a second preset condition, update the status information and update the color coding of each matrix unit. wherein the status information may be included in the second project document.

The quality rating refers to a quantitative or qualitative evaluation result given by quality inspection personnel after verifying and measuring the completed construction task results based on the acceptance criterion 1345. In some embodiments, the quality rating may be divided into a plurality of grades, for example, “Excellent”, “Good”, “Qualified”, “Unqualified”, and so on.

For example, if a completed construction task is “wall plastering”, its construction task sheet 1340 and the acceptance criterion 1345 define the following three key indicators: requiring inspection using a 2-meter straightedge, with the maximum gap at any position not exceeding 4 millimeters (surface flatness indicator); requiring inspection using a 2-meter plumb bob, with the deviation at any position not exceeding 5 millimeters (verticality indicator); and requiring the surface to be free of cracks, hollowing, sanding, and uniform in color (quality indicator). Then, when the quality inspection personnel conduct an inspection, if the aforementioned three key indicators are all satisfied, and the measured values of the key indicators (e.g., flatness, verticality) are better than 50% of the standard values, then the rating is “Excellent”; if the three key indicators are all satisfied but do not meet the conditions for “Excellent”, then the rating is “Good”. If the three key indicators are all satisfied, then the rating is “Qualified”. If any one of the key indicators is not satisfied, then the rating is “Unqualified”.

In some embodiments, the quality inspection personnel may input the inspection results from the site into the system 300.

The second preset condition refers to the minimum quality rating threshold that allows a construction task to be finally confirmed as “completed” and consequently triggers an update of the matrix unit status. In some embodiments, the second preset condition may be set as “quality rating of ‘Qualified’ and above”. In some embodiments, the second preset condition may be preset by project managers based on the quality management requirements of the project.

In some embodiments, in response to the quality rating of the construction task satisfying the second preset condition, the processor may update the status of the construction task to “acceptance qualified”, and consequently re-determine the status information and the color coding of corresponding matrix unit. For example, when the currently completed construction task is not the last construction task corresponding to the matrix unit, the processor may update the status information of the matrix unit (e.g., update the status information from 50% to 60%). As another example, if the currently completed construction task is the last construction task of the matrix unit, the processor may update the color coding of the matrix unit (e.g., update the yellow color representing “in progress” to green representing “completed”).

In some embodiments, the update of the color coding may also be associated with the quality rating. For example, for tasks with a higher quality rating, a color saturation of the corresponding matrix unit may be higher. Conversely, in response to the quality rating not meeting the second preset condition (for instance, rated as “unqualified”), the processor may not update the status information of the matrix unit.

In some embodiments, when the quality rating of the completed construction task is “unqualified”, the processor may not update the status information and color coding of the matrix unit. At the same time, the processor may generate a rectification notice and dispatch the rectification notice to a performance entity of the construction task, requesting the performance entity to make rectifications.

For more details about the selected construction task, the first task to be assigned, the matrix unit, the construction area, and the execution status, please refer to FIG. 10 and related descriptions thereof.

In some embodiments of the present disclosure, by introducing a quality rating-based update mechanism, the reliability and accuracy of project progress node data are ensured, this manner regards quality acceptance as a necessary prerequisite for progress update, avoiding a situation where tasks are confirmed as completed based solely on a statement of a contractor. It ensures that construction tasks displayed as “completed” in the visual view have corresponding engineering entity quality that is truly up to standard, and enables managers to make decisions based on more reliable data.

FIG. 14 is a flowchart illustrating an exemplary process for reassigning a second task to be assigned according to some embodiments of the present disclosure.

As shown in FIG. 14, a process 1400 includes the following operations 1410-1430. In some embodiments, the process 1400 may be executed by a processor.

In 1410, in response to detecting that an execution status of a first matrix unit is delayed, at least one second matrix unit affected by the first matrix unit is determined based on a node dependency network.

In some embodiments, the plurality of matrix units includes a first matrix unit. The first matrix unit refers to a matrix unit firstly detected to have an execution status of “delayed” when monitoring all currently executing matrix units. For example, if a matrix unit “Building 1, Floor 2 Main Structure” is the first unit in the system 300 determined to be behind schedule, then it is determined as the first matrix unit.

The execution status of “delayed” refers to an actual progress of a matrix unit falling behind its planned progress and exceeding a preset delay threshold. In some embodiments, whether the execution status is delayed may be determined by the aforementioned anomaly detection (referring to FIG. 13). For example, when a duration detection of a selected construction task fails, the execution status of the matrix unit to which it belongs may be updated to “delayed”.

The node dependency network refers to a data structure used for representing a basic logic (i.e., predecessor-successor dependency relationship) among a plurality of progress nodes. For example, the node dependency network may be a directed acyclic graph. In some embodiments, in the node dependency network, each progress node is a graph node, and a dependency relationship between the nodes is a directed edge. The processor may construct the node dependency network based on preset dependency data obtained from a progress node template library.

For example, the preset dependency data specifies that the start of “Main Structure Engineering” (progress node PN-02) must be predicated on the complete fulfillment of “Foundation and Infrastructure Engineering” (progress node PN-01), that is, the predecessor node ID of node PN-02 is PN-01. The processor creates a directed edge from PN-01 pointing to PN-02 between the graph node representing PN-01 and the graph node representing PN-02. This edge indicates that “PN-01 is a predecessor task of PN-02”.

For more details about the basic logic and the preset dependency data, please refer to FIG. 12 and related descriptions thereof.

The second matrix unit refers to a matrix unit whose corresponding progress node is a direct or indirect successor node of the progress node corresponding to the first matrix unit in the node dependency network. In one embodiment, the processor determines all reachable subsequent graph nodes and their corresponding matrix units as the affected second matrix units by performing graph traversal (for example, breadth-first or depth-first search) in the node dependency network, starting from the graph node corresponding to the first matrix unit.

In 1420, a second planned duration of the at least one second matrix unit and/or a priority of a second task to be assigned is re-determined based on a delay degree of the first matrix unit.

The delay degree of the first matrix unit refers to a parameter used for quantifying the magnitude of delay impact of the first matrix unit. In one embodiment, the delay degree of the first matrix unit may be a specific time duration, for example, “5 working days”. In some embodiments, the delay degree of the first matrix unit may be a sum of delay times of all currently completed construction tasks in the matrix unit. For example, if the first matrix unit has completed construction task 1 and construction task 2, the delay time of construction task 1 is 2 days and the delay time of construction task 2 is 3 days, then the delay degree of the first matrix unit is 5 days.

The second planned duration refers to a newly determined planned duration for a selected construction task or a first task to be assigned within the second matrix unit. The second task to be assigned refers to a selected construction task or a first task to be assigned within the second matrix unit. In some embodiments, the processor re-determines the second planned duration of the second matrix unit based on the delay degree of the first matrix unit by: obtaining the original planned duration (including the start time and the completion time) of a selected construction task or a first task to be assigned within the at least one second matrix unit; using the delay degree of the first matrix unit (for example, “5 working days”) as an extension amount to adjust the original planned duration of the selected construction task or the first task to be assigned within the at least one second matrix unit.

In one embodiment, the processor may adjust the planned duration of the second matrix unit to generate the second planned duration. For example, the original planned start date may be postponed according to the delay degree of the first matrix unit (such as “5 working days”) to generate the second planned duration of the second matrix unit.

In some embodiments, in response to detecting that the execution status of the first matrix unit is delayed, the processor may re-determine the weight coefficient (or the first weight coefficient, the second weight coefficient) of the second matrix unit and the priority of the second task to be assigned within the second matrix unit. For example, if the delay of the first matrix unit leads to a change in the project critical path, such that a certain second matrix unit enters a new critical path, then the processor may correspondingly increase a first weight coefficient and an overall priority of the second matrix unit.

For more details about how to determine the priority, the weight coefficient, the first weight coefficient, and the second weight coefficient, please refer to FIGS. 10 and 12 and related descriptions thereof.

In 1430, a selected construction task is re-determined and re-assigned based on the second planned duration and/or the priority of the second task to be assigned.

In some embodiments, the processor may re-determine and assign the selected construction task for the second task to be assigned based on the updated second planned duration and/or the priority, and generate a corresponding construction task sheet (referring to FIG. 13).

For more details about how to assign the selected construction task, please refer to FIG. 10 and related descriptions thereof.

In some embodiments of the present disclosure, dynamic and proactive management of project risks is achieved by introducing a delay impact analysis and a reassignment mechanism. This approach may automatically predict the scope of impact on subsequent tasks in the early stage of a delay event, adjust the related task plans in advance, transform passively accepting the consequences of the delay into proactively re-planning of schedules, thereby effectively controlling the spread of the delay impact. The scheduling and utilization of resources are optimized. By timely updating the planned duration of subsequent tasks, it may prevent subsequent teams from entering the site prematurely due to uncompleted preceding tasks, which results in idle work and idle resources, thereby improving a resource utilization efficiency of the overall project.

It should be noted that the foregoing descriptions of the processes 400, 500, 800, 1000, 1200, and 1400 are merely for the purpose of exemplification and illustration only and do not limit the scope of application of the present disclosure. For a person skilled in the art, various corrections and changes may be made to the processes 400, 500, 800, 1000, 1200, and 1400 under the guidance of the present disclosure. However, these corrections and changes remain within the scope of the present disclosure.

One or more embodiments of the present disclosure further provide a non-transitory computer-readable storage medium. The storage medium stores computer instructions, and when a computer reads the computer instructions in the storage medium, the computer executes the method described in any embodiment of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for discription purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system for project management, comprising: at least one processor and a memory storing computer instructions, wherein when the at least one processor executes the computer instructions, the system is configured to:
construct, based on construction area data and progress node data of a target project, a data structure of a construction progress matrix in the memory, wherein the data structure includes a plurality of matrix units, and each of the plurality of matrix units is uniquely associated with a construction area and a progress node;
query, based on feature values of project features of the target project, a pre-built general document directory library for matching candidate project documents, to generate and store a first document directory in the memory, wherein the first document directory records document tags of a plurality of first project documents corresponding to the target project, and a document tag includes a construction area tag, a progress node tag, and a database tag identifying a storage position;
for a target matrix unit in the data structure of the construction progress matrix, screen out a second project document from the plurality of first project documents by matching and querying construction area data and progress node data of the target matrix unit with construction area tags and progress node tags of the plurality of first project documents, and generate a second document directory corresponding to the target matrix unit;
monitor, in real time, a status change event of the second project document by a listener deployed on a business database which corresponds to the second project document and is specified by the database tag; and
automatically update, in response to detecting the status change event, index information corresponding to the second project document in the second document directory.

2. The system for project management of claim 1, wherein the general document directory library is configured to store a correspondence between reference values of project features and a plurality of types of project documents, and a document tag of each type of project document, and the general document directory library is constructed by:
obtaining sample document directories of a plurality of sample projects and feature values of project features of each of the plurality of sample projects;
determining, based on the sample document directories, a distribution of feature values of project features corresponding to each type of project document; and
determining, based on the distribution of the feature values, reference values of the project features corresponding to each type of project document.

3. The system for project management of claim 1, wherein the document tag further includes a warning rule tag and a disposal rule tag, and the system is further configured to:
determine, in response to detecting generation of the second project document, a warning rule of the second project document based on a warning rule tag of the second project document, wherein the warning rule is configured to constrain a generation time of related data of the second project document;
obtain monitoring information related to the related data, and determine, based on the monitoring information, whether the related data complies with the warning rule; and
implement, in response to determining that the related data does not comply with the warning rule, a corresponding disposal operation based on a disposal rule tag of the second project document.

4. The system for project management of claim 3, wherein the document tag further includes an affiliated unit tag, and the related data includes a third project document, among the plurality of first project documents, related to the second project document;
obtaining the monitoring information related to the related data includes: obtaining, based on a database tag of the third project document, monitoring information related to the third project document; and
implementing the corresponding disposal operation based on the disposal rule tag includes: sending, based on an affiliated unit tag of the third project document, a notification to an affiliated unit corresponding to the third project document.

5. The system for project management of claim 1, wherein the system is further configured to:
determine, based on an updated second document directory, whether a target progress node corresponding to the target matrix unit satisfies a progress node update condition;
determine, in response to determining that the target progress node satisfies the progress node update condition, an associated matrix unit associated with the target matrix unit based on relationship information related to the data structure of the construction progress matrix; and
send a construction notification to a target affiliated unit of the associated matrix unit.

6. The system for project management of claim 5, wherein the document tag further includes an affiliated unit tag and a construction task tag, and sending the construction notification to the target affiliated unit of the associated matrix unit includes:
determining, based on construction area tags and progress node tags of the plurality of first project documents, fourth project documents corresponding to the associated matrix unit;
determining, based on construction task tags of the fourth project documents, a target fourth project document, wherein a construction time corresponding to the target fourth project document satisfies a first preset condition; and
determining the target affiliated unit based on an affiliated unit tag of the target fourth project document, and sending the construction notification to the target affiliated unit.

7. The system for project management of claim 1, wherein the system is further configured to:
generate a progress display table corresponding to the data structure of the construction progress matrix, wherein the progress display table includes display cells corresponding to the plurality of matrix units;
determine, based on an updated second document directory, progress information of the target matrix unit; and
annotate, based on the progress information, a display cell corresponding to the target matrix unit in the progress display table.

8. The system for project management of claim 1, wherein the system is further configured to:
determine, in response to detecting that the second project document is stored in the business database, a digital hash value of the second project document;
invoke a smart contract of a blockchain network, package the digital hash value, the document tag, and a timestamp into a transaction, and send the transaction to the blockchain network for evidence preservation; and
receive a transaction receipt returned by the blockchain network, and update a transaction hash in the transaction receipt into the second document directory as tamper-proof index information of the second project document.

9. The system for project management of claim 1, wherein the system is further configured to:
obtain text content of the second project document;
extract, based on the text content, at least one semantic feature vector by a processing model, wherein the processing model is a machine learning model;
determine, based on the at least one semantic feature vector and the progress node data of the target matrix unit, a progress delay probability of the target matrix unit by a progress prediction model, wherein the progress prediction model is a machine learning model; and
perform, in response to the progress delay probability exceeding a preset threshold, a risk warning annotation on the target matrix unit.

10. The system for project management of claim 1, wherein the system is further configured to:
render, on a display device, a three-dimensional (3D) building information model of the target project;
spatially bind the plurality of matrix units in the data structure of the construction progress matrix with building components in the 3D building information model;
determine, in response to a selection operation from a user on a target component in the 3D building information model, a matrix unit corresponding to the target component from the data structure of the construction progress matrix, and invoke a second document directory associated with the matrix unit corresponding to the target component; and
display, in a floating window of a graphical user interface (GUI), a document list in the second document directory.

11. The system for project management of claim 1, wherein the system is further configured to:
for each of the plurality of matrix units:
determine, based on a difference set between a plurality of construction tasks and completed construction tasks of the matrix unit, a first task to be assigned of the matrix unit;
determine, based on a weight coefficient of the matrix unit, a priority of the first task to be assigned;
determine a selected construction task based on the priority of the first task to be assigned and assign the selected construction task;
update and perform color coding on status information of the matrix unit based on an execution status of the selected construction task; and
generate a visualization view displaying visual progress, wherein the visualization view includes a view presented in a two-dimensional table format; and in the view presented in the two-dimensional table format, a vertical axis displays a plurality of construction areas of the target project, and a horizontal axis displays a plurality of progress nodes of the target project.

12. The system for project management of claim 11, wherein the plurality of matrix units are generated by:
performing a spatial conflict verification on a plurality of construction spaces required by the plurality of construction areas and the plurality of progress nodes; and
in response to spatial conflict verification of a plurality of target construction spaces among the plurality of construction spaces passing, generating the plurality of matrix units corresponding to a plurality of target construction areas and a plurality of target progress nodes corresponding to the plurality of target construction spaces.

13. The system of claim 11, wherein determining, based on the weight coefficient of the matrix unit, the priority of the first task to be assigned includes:
determining a first weight coefficient of the matrix unit based on a basic logic among the plurality of progress nodes;
determining a second weight coefficient of the matrix unit based on progress pressure of the matrix unit; and
determining the priority of the first task to be assigned based on a comprehensive result of the first weight coefficient and the second weight coefficient.

14. The system of claim 13, wherein determining the second weight coefficient of the matrix unit based on the progress pressure of the matrix unit includes:
determining the second weight coefficient based on first progress pressure of a construction area corresponding to the matrix unit and second progress pressure of a progress node corresponding to the matrix unit.

15. The system of claim 11, wherein the second project document includes a construction task sheet, and determining the selected construction task based on the priority of the first task to be assigned and assigning the selected construction task includes:
generating a construction task sheet corresponding to the matrix unit based on the selected construction task, wherein the construction task sheet includes a construction area, a construction task procedure, a work disclosure, a safety disclosure, and an acceptance criterion corresponding to the matrix unit.

16. The system of claim 15, wherein the construction task sheet further includes a first planned duration, a resource requirement, and a performance entity, and determining the selected construction task based on the priority of the first task to be assigned and assigning the selected construction task includes:
predicting the first planned duration and the resource requirement by a prediction algorithm based on historical construction data; and
determining the performance entity by a capability database based on the first planned duration and the resource requirement.

17. The system of claim 16, wherein updating and performing color coding on the status information of the matrix unit based on the execution status of the selected construction task includes:
performing an anomaly detection on the execution status based on the construction task sheet, wherein the anomaly detection includes a duration detection and a resource consumption detection; and
in response to the anomaly detection failing, issuing a warning for each of the plurality of progress nodes.

18. The system of claim 15, wherein updating and performing color coding on the status information of the matrix unit based on the execution status of the selected construction task includes:
in response to the selected construction task being completed, performing a quality rating on the selected construction task based on the acceptance criterion; and
in response to the quality rating satisfying a second preset condition, updating the status information and updating the color coding of the matrix unit.

19. The system of claim 11, wherein the plurality of matrix units include a first matrix unit, and the system is further configured to:
in response to detecting that an execution status of the first matrix unit is delayed, determine at least one second matrix unit affected by the first matrix unit based on a node dependency network;
re-determine a second planned duration of the at least one second matrix unit and/or a priority of a second task to be assigned based on a delay degree of the first matrix unit; and
re-determine the selected construction task based on the second planned duration and/or the priority of the second task to be assigned and re-assign the selected construction task.

20. The system of claim 11, wherein generating the visualization view for displaying intuitive progress includes:
obtaining a plurality of pieces of position information of the plurality of construction areas and a plurality of pieces of status information of the plurality of matrix units; and
mapping, based on the plurality of pieces of position information, the plurality of pieces of status information to corresponding spatial positions in a virtual building model, to form a visualized 3D view.
